(19) United States
(12) Patent Application Publication
(10) Pub. No.: US 2017/0267049 A1
(43) Pub. Date: Sep. 21, 2017

(54) Suspension Control Apparatus, Suspension Control Method, and Program

(71) Applicant: KYB Corporation, Tokyo (JP)

(72) Inventors: Tomoo Kubota, 4-1, Hamamatsu-cho 2-chome, Minato-ku (JP); Masatoshi Okumura, Tokyo (JP)

(21) Appl. No.: 15/505,482

(22) PCT Filed: Jul. 29, 2015
(86) PCT No.: PCT/JP2015/071454

§ 371 Date: Feb. 21, 2017

(30) Foreign Application Priority Data
Aug. 19, 2014 (JP) 2014-166574

(51) Int. Cl. B60G 17/019; B60G 17/06

(52) U.S. Cl. CPC B60G 17/01933; B60G 17/06; B60G 2600/181; B60G 2500/10

(57) ABSTRACT

[Object] To provide a suspension control apparatus, a suspension control method, and a program, by which unsprung vibrations or sprung vibrations of each wheel can be efficiently suppressed.

[Solving Means] A suspension control apparatus (20) includes a signal generator (40) and a control unit (50). The signal generator (40) generates a first state signal regarding unsprung vibrations of a first wheel and a second state signal regarding unsprung vibrations of a second wheel. The control unit (50) generates, on the basis of the first and second state signals, a control signal for mutually and cooperatively controlling a first damper mounted on the first wheel and a second damper mounted on the second wheel.

### TECHNICAL FIELD

The present invention relates to a suspension control apparatus that controls suspension of a vehicle, a suspension control method, and a program.

### BACKGROUND ART

Conventionally, there is an active suspension system as a suspension system for a vehicle. The active suspension system actively controls suspension on the basis of skyhook theory, to thereby give both driving comfort and steering stability. A semi-active suspension system is one of such active suspension systems. The semi-active suspension system uses a shock absorber (damper) having a variable damping force (strictly speaking, damping characteristic) and variably controls the damping characteristic thereof when damping has to be performed on a vehicle body or vehicle wheel is required.

The damping force of the damper is approximately proportional to a vertical speed of the vehicle wheel when an unsprung portion vibrates. Therefore, under such a condition, it is general that the damping force of the damper is controlled using a vertical vibration speed of the vehicle wheel as a control indicator. For example, Patent Literature 1 has described a suspension control apparatus that sequentially generates an envelope waveform of an unsprung vertical speed of a vehicle and calculates a target damping force of a shock absorber on the basis of the envelope waveform.

### CITATION LIST

### Patent Literature

Patent Literature 1: Japanese Patent Application Laid-open No. 2011-225040

### DISCLOSURE OF INVENTION

### Technical Problem

In the technology described in Patent Literature 1, a damping force for damping unsprung vibrations is generated with respect to an unsprung vibration level on a wheel-by-wheel basis. Thus, for a wheel whose unsprung portion vibrates, the damping force is increased by such control, and vibrations are suppressed. However, a reaction force of that damping force may be transmitted to other wheels through the vehicle body, the vehicle axles, and the like, and unsprung vibrations of the other wheels can be excited. The damping force control on one wheel may largely influence other wheels in this manner. It can make it impossible to efficiently suppress unsprung vibrations or sprung vibrations of each wheel.

In view of the above-mentioned circumstances, it is an object of the present invention to provide a suspension control apparatus and a suspension control method, by which unsprung or sprung vibrations of each wheel can be efficiently suppressed.

### Solution to Problem

A suspension control apparatus according to an embodiment of the present invention includes a signal generator and a control unit.

The signal generator generates a first state signal regarding unsprung vibrations of a first wheel and a second state signal regarding unsprung vibrations of a second wheel.

The control unit generates, on the basis of the first and second state signals, a control signal for mutually and cooperatively controlling a first damper mounted on the first wheel and a second damper mounted on the second wheel.

In the suspension control apparatus, unsprung vibrations of at least the first and second wheels are controlled in such a manner that they are cooperated with each other. The second wheel is typically a wheel opposite to the first wheel (e.g., if the first wheel is a left front wheel, the second wheel is a right front wheel). With this, not only unsprung vibrations generated in the first wheel, but also unsprung vibrations or sprung vibrations of the second wheel that are excited by those unsprung vibrations of the first wheel are effectively suppressed. With this, it becomes possible to efficiently suppress unsprung vibrations or sprung vibrations of the left and right wheels in comparison with the case of individually controlling each wheel.

The control unit is typically configured to generate, when detecting unsprung vibrations of at least one of the first and second wheels, a first control command to electrically control a vibration damping characteristic of the first damper and a second control command to electrically control a vibration damping characteristic of the second damper, as the control signal.

With this, for example, unsprung vibrations of the other wheel not vibrating, which are induced by a reaction force caused due to damping control on the one vibrating wheel, are suppressed, and the influence of the reaction force on the other wheel is reduced.

The control unit may be configured to generate the first and second control commands such that the vibration damping characteristic of the first damper is larger than the vibration damping characteristic of the second damper when the first state signal is larger than the second state signal.

With this, it is possible to realize suspension control performed mainly for driving comfort.

Alternatively, the control unit may be configured to generate the first and second control commands such that the vibration damping characteristic of the first damper is smaller than the vibration damping characteristic of the second damper when the first state signal is larger than the second state signal.

With this, it is possible to realize suspension control by which a roll of a vehicle body can be suppressed.

Alternatively, the control unit may be configured to generate the first and second control commands such that the vibration damping characteristic of the first damper is equal to the vibration damping characteristic of the second damper when the first state signal is larger than the second state signal.

With this, it is possible to realize conventional vehicle feeling that is not of a damping force variable type.

Magnitude of the first and second control commands can be determined by magnitude of control parameters (gains) used in calculation of those control commands.

For example, the control unit includes a first control command calculation unit and a second control command calculation unit.

The first control command calculation unit is configured to generate the first control command on the basis of a maximum value selected from a multiplication value obtained by multiplying the first state signal by a first gain and a multiplication value obtained by multiplying the second state signal by a second gain different from the first gain.

The second control command calculation unit is configured to generate the second control command on the basis of a maximum value selected from a multiplication value obtained by multiplying the first state signal by a third gain identical to the second gain and a multiplication value obtained by multiplying the second state signal by a fourth gain identical to the first gain.

By determining correlations among the first to fourth gains in a manner that depends on control purposes such as driving comfort, roll suppression, and vehicle feeling, it is possible to rapidly stabilize the wheel in which unsprung vibrations are generated and efficiently control vibrations of the other wheel and sprung vibrations.

A reference may be made to the first and second unsprung control commands by referring not only unsprung vibration information of the first and second wheels but also unsprung vibration information of other wheels.

For example, the signal generator is configured to further generate a third state signal regarding unsprung vibrations of a third wheel opposite to the first wheel in front and rear directions and a fourth state signal regarding unsprung vibrations of a fourth wheel opposite to the third wheel in the left- and right-hand directions.

In this case, the first control command calculation unit is configured to generate the first control command on the basis of a maximum value selected from the multiplication value obtained by multiplying the first state signal by the first gain, the multiplication value obtained by multiplying the second state signal by the second gain, a multiplication value obtained by multiplying the third state signal by a fifth gain, and a multiplication value obtained by multiplying the fourth state signal by a sixth gain different from the fifth gain.

On the other hand, the second control command calculation unit is configured to generate the second control command on the basis of a maximum value selected from the multiplication value obtained by multiplying the first state signal by the third gain, the multiplication value obtained by multiplying the second state signal by the fourth gain, a multiplication value obtained by multiplying the third state signal by a seventh gain identical to the sixth gain, and a multiplication value obtained by multiplying the fourth state signal by an eighth gain identical to the fifth gain.

The first and second wheels may be left and right front wheels or may be left and right rear wheels.

The control unit may be configured to variably control values of the first to fourth gains in a manner that depends on a speed of a vehicle.

With this, for example, it becomes possible to automatically change from suspension control performed mainly for the driving comfort to suspension control performed mainly for the roll suppression as the speed of the vehicle increases.

In order to realize such control, for example, the control unit is configured to set the second gain to a value smaller than the fourth gain and reduce a difference between the second gain and the fourth gain as the speed of the vehicle increases when the speed of the vehicle is within a first speed range.

On the other hand, the control unit is configured to set the second gain to a value equal to or larger than the fourth gain and increase the difference between the second gain and the fourth gain as the speed of the vehicle increases when the speed of the vehicle is within a second speed range equal to or higher than the first speed range.

The suspension control apparatus may further include a limiter processing unit.

The limiter processing unit is configured to be capable of individually setting, in a manner that depends on magnitude of unsprung vibrations of each of a plurality of wheels, an upper-limit limiter value in a direction in which a damping force characteristic increases, with respect to each control command.

With this, it becomes possible to prevent the control command from being unnecessarily excessively large. Or, it becomes possible to prevent the control command from being a control command (current command) equal to or larger than a current value that can be output.

The limiter processing unit may be configured to monitor magnitude of unsprung vibrations of each wheel, and gradually reduce a control command to the wheel whose unsprung vibrations become larger, in a direction in which the damping force characteristic decreases, as the unsprung vibrations become larger.

With this, when unsprung vibration levels are high in all wheels cooperatively controlled, it is possible to prevent control commands of all the wheels from being unnecessarily large.

Further, the limiter processing unit may be configured to change the upper-limit limiter value on the basis of at least one of the predetermined correlation and the vehicle speed.

With this, it is possible to extend a range for controlling the vehicle feeling in a manner that depends on the vehicle type, specifications, vehicle speed, and the like.

The signal generator may be configured to acquire, from a plurality of sensors mounted on a vehicle, a plurality of detection signals including information regarding unsprung vibrations of the first wheel, and generate the first state signal on the basis of the plurality of detection signals.

With this, it is possible to improve reliability of the first state signal.

Note that it is applicable not only to generation of the first state signal but also to generation of state signals of the other wheels.

A suspension control method according to an embodiment of the present invention includes acquiring a plurality of unsprung vibration information items regarding unsprung vibrations of each of a plurality of wheels.

A control signal for mutually and cooperatively controlling a plurality of dampers mounted on the plurality of wheels is generated on the basis of the plurality of unsprung vibration information items.

A program according to an embodiment of the present invention causes a suspension control apparatus to execute the steps of: acquiring first unsprung vibration information regarding unsprung vibrations of a first wheel, and second unsprung vibration information regarding unsprung vibrations of a second wheel opposite to the first wheel in left- and right-hand directions; calculating a multiplication value obtained by multiplying the first state signal by a first gain, calculating a multiplication value obtained by multiplying the second state signal by a second gain different from the first gain, and generating, on the basis of a maximum value selected from the multiplication values, a first control command to electrically control a vibration damping characteristic of a first damper mounted on the first wheel; and calculating a multiplication value obtained by multiplying the first state signal by a third gain identical to the second gain, calculating a multiplication value obtained by multiplying the second state signal by a fourth gain identical to the first gain, and generating, on the basis of a maximum value selected from the multiplication values, a second control command to electrically control a vibration damping characteristic of a second damper mounted on the second wheel.

### Advantageous Effects of Invention

In accordance with the present invention, unsprung vibrations or sprung vibrations of each wheel can be efficiently suppressed.

### BRIEF DESCRIPTION OF DRAWINGS

FIG. 1 A schematic diagram of an independent suspension apparatus.

FIG. 2 A schematic diagram of a beam-axle suspension apparatus.

FIG. 3 A block diagram showing a configuration of a suspension control apparatus according to a first embodiment of the present invention.

FIG. 4 A block diagram schematically showing a configuration of a signal generator and a control unit in the suspension control apparatus.

FIG. 5 A block diagram for describing functions of an unsprung control command calculation unit in the control unit.

FIG. 6 A functional block diagram of the suspension control apparatus.

FIG. 7 A schematic diagram for describing an application example of the suspension control apparatus to a vehicle.

FIG. 8 A typical control flow of the suspension control apparatus.

FIG. 9 A diagram for describing an application example of the suspension control apparatus.

FIG. 10 A diagram for describing an application example of the suspension control apparatus.

FIG. 11 A diagram for describing an application example of the suspension control apparatus.

FIG. 12 A diagram for describing another application example of the suspension control apparatus.

FIG. 13 A diagram for describing another application example of the suspension control apparatus.

FIG. 14 A diagram for describing another application example of the suspension control apparatus.

FIG. 15 A block diagram showing a suspension control apparatus according to a second embodiment of the present invention.

FIG. 16 A diagram for describing an action of the suspension control apparatus.

FIG. 17 A typical control flow of the suspension control apparatus of FIG. 15.

FIG. 18 A block diagram showing a suspension control apparatus according to a third embodiment of the present invention.

FIG. 19 An explanatory diagram showing an example of control in the suspension control apparatus of FIG. 18.

FIG. 20 An explanatory diagram showing another example of control in the suspension control apparatus of FIG. 18.

FIG. 21 A typical control flow of the suspension control apparatus of FIG. 18.

FIG. 22 A block diagram showing a suspension control apparatus according to a fourth embodiment of the present invention.

FIG. 23 A schematic view for describing an arrangement example of various sensors installed in the vehicle.

FIG. 24 A diagram showing a form of a state signal in the embodiment of the present invention.

FIG. 25 A diagram for describing another form of the state signal.

FIG. 26 A diagram for describing another form of the state signal.

FIG. 27 A diagram for describing another form of the state signal.

FIG. 28 A diagram for describing another form of the state signal.

FIG. 29 A diagram for describing a generation method for the state signal.

FIG. 30 A diagram for describing another generation method for the state signal.

FIG. 31 A diagram for describing another generation method for the state signal.

FIG. 32 A plan view of a vehicle for describing an arrangement example of various sensors.

FIG. 33 A diagram for describing an acquisition method for the state signal.

FIG. 34 A diagram for describing another acquisition method for the state signal.

FIG. 35 A plan view of a vehicle for describing another arrangement example of the various sensors.

FIG. 36 A diagram for describing a detection example of unsprung vibration information.

FIG. 37 A plan view of a vehicle for describing another arrangement example of the various sensors.

FIG. 38 A plan view of a vehicle for describing another arrangement example of the various sensors.

FIG. 39 A block diagram showing another configuration example of the suspension control apparatus.

FIG. 40 A diagram for describing an action of the suspension control apparatus.

FIG. 41 A diagram for describing a processing example of the suspension control apparatus.

FIG. 42 A diagram for describing the processing example.

FIG. 43 A diagram for describing another processing example of the suspension control apparatus.

FIG. 44 A diagram for describing the processing example with a comparison example.

FIG. 45 A diagram for describing the processing example with another comparison example.

### MODE(S) FOR CARRYING OUT THE INVENTION

Hereinafter, an embodiment of the present invention will be described with reference to the drawings. Here, a suspension control apparatus and a suspension control method of this embodiment will be described exemplifying semi-active suspension control.

<Outline of Semi-Active Suspension Control>

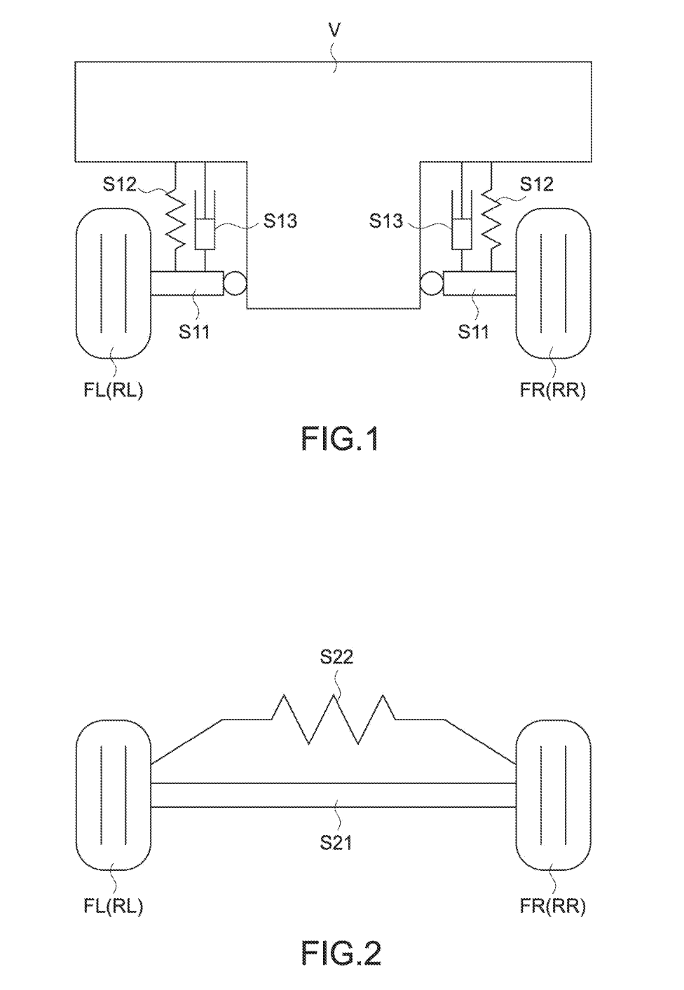

First of all, the outline of the semi-active suspension control will be described. FIG. 1 is a schematic diagram showing a basic configuration of an independent suspension apparatus.

As shown in FIG. 1, the suspension apparatus includes suspension arms S11, springs S12, and dampers (shock absorbers) S13. Each of the suspension arms S11 is disposed between each of the vehicle wheels (left front wheel FL, left rear wheel RL, right front wheel FR, and right rear wheel RR) and a vehicle body V. The suspension arms S11 mainly support the vehicle wheels to the vehicle body in a swingable manner. The springs S12 support vehicle weight. The dampers (shock absorbers) S13 damp vibrations of the springs.

In the semi-active suspension control, a damping force variable damper apparatus is used as the damper S13, and a damping characteristic of the damper S13 is variably controlled when damping has to be performed on the vehicle wheel, for example. A vertical vibration level (unsprung vibration level) of the vehicle wheel is typically used as an indicator for controlling the damping force, an optimal damping force is calculated in a manner that depends on this vibration speed, and a control signal for setting the calculated damping force is output to the damper S13. Each damper S13 is individually controlled in a manner that depends on the vibration level of the corresponding vehicle wheel.

By the way, when the semi-active suspension control as described above is applied to each wheel, a damping force in a wheel whose unsprung portion vibrates is increased and vibrations thereof are suppressed. However, vibrations of that wheel (or a reaction force in suppressing those vibrations) also largely influence other wheels. For example, unsprung vibrations influences the wheel opposite thereto in left- and right-hand directions through a vehicle axle and a stabilizer. Sprung vibrations also influence the wheels other than that wheel because the vehicle body can be considered as a substantially rigid body.

On the other hand, the influence of unsprung vibrations on the other wheels is not necessarily large, and hence a threshold value for setting a large damping force characteristic to the unsprung vibration level is not exceeded in the other wheels in many cases. Thus, when only a wheel whose unsprung portion vibrates is set to have a larger damping force, vibrations of that wheel are suppressed while other wheels are not necessarily set to have a larger damping force. Therefore, there is a fear that small vibrations may be continued in the other wheels. In this case, uncomfortable feeling may be given. For example, damping feeling against unsprung vibrations differs among the wheels.

Further, in the case where a damping force of only a certain wheel is increased as described above, it is necessary to consider which part receives a reaction force of the damping force. If an unsprung portion of a certain wheel vibrates, when vibrations thereof are suppressed by a damping force of the damper, a reaction force thereof is received by the unsprung portion of the self-wheel. Other than the unsprung portion of the self-wheel, it is received by an unsprung portion of an opposite wheel through the vehicle axle and the stabilizer and also by a sprung portion. Since the reaction force is received by the sprung portion, sprung portions of all three other wheels are basically influenced although it depends on where the center of weight of the vehicle body is.

In view of the fact that the reaction force (or a movement due to that reaction force) influences all the wheels through the vehicle axle and the stabilizer or the sprung portions in this manner, even if the damping force is increased for suppressing vibrations of the wheel whose unsprung portion is vibrating in the case where the damping forces of the other wheels are small, members that receive the reaction force are easily moved, and hence vibrations cannot be efficiently suppressed and a part of vibration energy escapes to the other wheels. Also from such a reason, it cannot be said that increasing a damping force of only a certain vibrating wheel for suppressing vibrations thereof is necessarily an efficient damping method.

Referring to the suspension apparatus shown in FIG. 1 again from such a point of view, it is theoretically impossible that, for example, unsprung vibrations of the left wheel FL (RL) influence unsprung vibrations of the right wheel FR (RR) under the condition that the stabilizer is not provided and the sprung portion is immobile. On the other hand, as shown in FIG. 2, in a beam-axle suspension apparatus in which left and right wheels are connected to each other through a vehicle axle S21 and a stabilizer S22, it is obvious that unsprung vibrations of the left wheel FL (RL) influence unsprung vibrations of the right wheel FR (RR).

Provided that the sprung portion is movable in FIG. 1, when the unsprung portion of the left wheel FL (RL) vibrates, the sprung portion of the left wheel is also largely moved at an unsprung vibration frequency. Due to this influence, the sprung portion of the right wheel FR (RR) is also largely moved at the unsprung vibration frequency. The movement of the sprung portion of the right wheel causes the suspension to be actuated. Thus, a reaction force of that suspension influences the unsprung portion of the right wheel. In addition, sprung resonance is induced because the unsprung portion and the sprung portion have different specific vibration frequencies. The suspension and the unsprung portion of the right wheel are moved due to not only the unsprung vibrations of the left wheel but also the influence of the sprung resonance. It should be noted that their movements are smaller in comparison with the left wheel as a matter of course.

Further, in many cases, the stabilizer is actually provided even in the case of independent suspension type as shown in FIG. 1. Unsprung vibrations of the left wheel are transmitted to the unsprung portion of the right wheel through this stabilizer, having a vibration transmission gain equal to or larger that in transmission through the sprung portion.

In addition, the front portion and the rear portion are different in the tread width, lever ratio, sprung shared mass, and the like. Therefore, the damping force necessary for suppressing various types of vibrations cannot be uniquely determined. Therefore, in actual vehicle adaptation (tuning), the damping forces of the front portion and the rear portion are adjusted on the basis of actual vehicle sensory evaluation results.

In view of the above-mentioned circumstances, the suspension control apparatus according to this embodiment aims at increasing the efficiency of unsprung vibration suppression of each wheel, suppressing the occurrence of sprung vibrations, and making the vehicle feeling favorable both in the case where unsprung vibrations occur in a certain wheel and in the case where unsprung vibrations occur in a plurality of wheels.

### First Embodiment

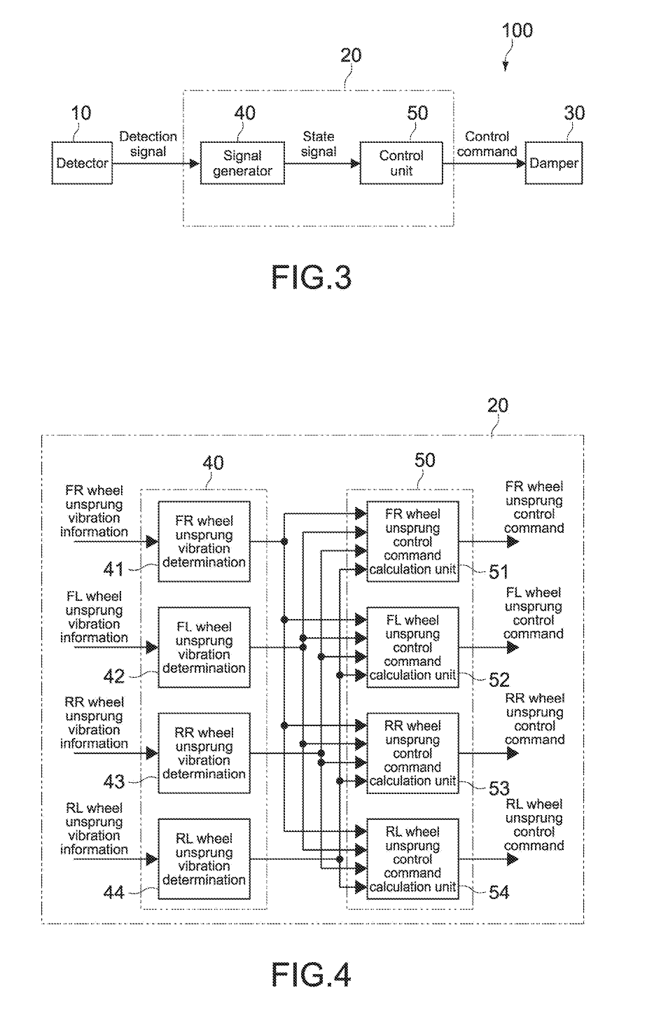

FIG. 3 is a block diagram showing a suspension control system according to an embodiment of the present invention. A suspension control system 100 of this embodiment can be employed for a vehicle, typically, a four-wheel automobile.

[Overall Configuration]

The suspension control system 100 includes a detector 10 including a plurality of sensors, a suspension control apparatus 20, and a plurality of dampers 30 attached to vehicle wheels.

The detector 10 includes various sensors that provide information related to behaviors of the vehicle. The various sensors include a plurality of sprung acceleration sensors, a plurality of displacement sensors attached to the wheels, and a plurality of vehicle wheel speed sensors attached to the wheels.

The plurality of sprung acceleration sensors are, for example, attached at arbitrary positions of a vehicle body (chassis). The plurality of sprung acceleration sensors detect sprung acceleration of each wheel or sprung acceleration common to the plurality of wheels. The displacement sensors are, for example, attached between the vehicle body and suspension arms. The displacement sensors detect a relative displacement thereof, that is, a relative displacement (suspension displacement) between the sprung portion and the unsprung portion. The vehicle wheel speed sensors detect rotational speeds of the vehicle wheels and are attached to, for example, wheel hubs.

Note that the detector 10 may include unsprung acceleration sensors and the like in addition to or instead of the sprung acceleration sensors, the displacement sensors, and the vehicle wheel speed sensors. The types of those sensors are merely examples and specifications thereof may depends on the vehicle type. Further, the number of sensors, sensor attachment positions, and the like are appropriately set in a manner that depends on the vehicle type. In addition, all the sensors are not limited to be installed in one vehicle. For example, either the unsprung acceleration sensors or the displacement sensors are often installed in one vehicle.

A damping force (strictly speaking, damping characteristic or damping coefficient) variable damper can be, for example, employed as each of the dampers 30. Examples of the damping characteristic variable damper include a magneto-rheological fluid type, a proportional solenoid type, and an electro-rheological fluid type. With the magneto-rheological fluid type or the proportional solenoid type, a control command value is a current value. With the electro-rheological fluid type, the control command value is a voltage value. Therefore, the term “current value” shown below can be replaced by the “voltage value”.

A vibration damping characteristic of the damper 30 of each wheel is independently controlled by receiving an input of a control signal (unsprung control command) output from a control unit 50. Unsprung vibrations of each wheel are damped using the controlled vibration damping characteristic.

[Suspension Control Apparatus]

The suspension control apparatus 20 is configured to determine an unsprung vibration state of each wheel on the basis of various detection values from the detector 10 and generate, on the basis of the determination result, a control signal (control command) for controlling a damping force or damping characteristic of each damper 30.

Hereinafter, the suspension control apparatus 20 will be described in detail.

The suspension control apparatus 20 includes a signal generator 40 and the control unit 50. The suspension control apparatus 20 can be typically realized by hardware elements used in a computer, such as a CPU (Central Processing Unit), a RAM (Random Access Memory), and a ROM (Read Only Memory) (not shown), and necessary software. Instead of or in addition to the CPU, a PLD (Programmable Logic Device) such as an FPGA (Field Programmable Gate Array), or a DSP (Digital Signal Processor), or the like may be used. A suspension control program to be executed in the control unit 50, control parameters (gain matrix G₁₁ to G₄₄ (FIG. 6)) necessary for executing that program, and the like are stored in the ROM. The signal generator 40 and the control unit 50 may be configured as an identical unit or may be configured as separated units.

(Signal Generator)

The signal generator 40 constitutes a “signal processing apparatus” that acquires, from the detector 10, a detection signal including unsprung vibration information of each wheel, determines an unsprung vibration state of each wheel, and generates a state signal regarding unsprung vibrations of each wheel. The generated state signal of each wheel is output to the control unit 50.

Here, the unsprung vibration information refers to information regarding unsprung vibrations. The unsprung vibration information is a signal that is a basis for determining a vibration condition of the unsprung portion. The unsprung vibration information may be a certain sensor signal as it is or may be information obtained by processing the sensor signal.

A method of determining the unsprung vibration state (unsprung vibration determination) is not particularly limited and can be appropriately set in a manner that depends on an output form of the detector 10 and the like. For example, if the output of the detector 10 is an ON/OFF signal, it is only necessary to turn ON when the unsprung vibration information exceeds a certain threshold value and turn OFF after a prescribed time has elapsed in this state. Further, if the output of the detector 10 is a signal that fluctuates over time, it is only necessary to calculate an unsprung vibration level or the like and output that value to the control unit 50, for example.

Note that, if the unsprung vibration level that is information is already present as the unsprung vibration information, the unsprung vibration determination may be omitted.

(Control Unit)

The control unit 50 is configured to calculate, on the basis of a state signal of each wheel that is output from the signal generator 40, an unsprung control command (control signal) to the wheel and output it to the damper 30 corresponding to the wheel.

FIG. 4 is a block diagram schematically showing typical configurations of the signal generator 40 and the control unit 50.

As shown in FIG. 4, the signal generator 40 is configured to determine an unsprung vibration state on a wheel-by-wheel basis. That is, the signal generator 40 includes an FR wheel unsprung vibration determination unit 41 that determines unsprung vibrations of the right front wheel, an FL wheel unsprung vibration determination unit 42 that determines unsprung vibrations of the left front wheel, an RR wheel unsprung vibration determination unit 43 that determines unsprung vibrations of the right rear wheel, and an RL wheel unsprung vibration determination unit 44 that determines unsprung vibrations of the left rear wheel.

Similarly, the control unit 50 is configured to generate an unsprung control command on a wheel-by-wheel basis. That is, the control unit 50 includes an FR wheel unsprung control command calculation unit 51 that generates an unsprung control command of the right front wheel, an FL wheel unsprung control command calculation unit 52 that generates an unsprung control command of the left front wheel, an RR wheel unsprung control command calculation unit 53 that generates an unsprung control command of the right rear wheel, and an RL wheel unsprung control command calculation unit 54 that generates an unsprung control command of the left rear wheel.

Each of the vibration determination units 41 to 44 acquires, from the output of the detector 10, information necessary for determining an unsprung vibration state of a wheel that is a target, and outputs a state signal associated with this unsprung vibration state of each wheel to each of the unsprung control command calculation units 51 to 54.

Note that a specific acquisition method for the unsprung vibration information of each wheel will be described later.

The control unit 50 is configured to generate, on the basis of the state signal regarding unsprung vibrations of each wheel, a control signal for mutually and cooperatively controlling the plurality of dampers 30 mounted on the plurality of wheels.

In this embodiment, the control unit 50 generates unsprung control commands for controlling damping forces of the dampers of the wheels, on the basis of information regarding unsprung vibrations of not only the self-wheel but also the other wheels. That is, as shown in FIG. 4, each of the control command calculation units 51 to 54 acquires, from each of the unsprung vibration determination units 41 to 44, information regarding unsprung vibrations of each wheel, and outputs an unsprung control command for determining a damping force against unsprung vibrations of the self-wheel while referring to unsprung vibration states of the other wheels.

In order to realize cooperative control on the dampers, the control unit 50 is configured to generate individually and concurrently (it does not need to be strictly concurrent) an unsprung control command I_{FR} (first control command) for controlling a vibration damping characteristic of the damper 30 of the FR wheel and an unsprung control command Iv (second control command) for controlling a vibration damping characteristic of the damper 30 of the FL wheel opposite to the FR wheel in the left- and right-hand directions, and to cause those unsprung control commands to have a predetermined correlation therebetween.

“Having a predetermined correlation” typically refers to establishing a predetermined magnitude relationship between the vibration damping characteristic of the damper 30 of the FR wheel and the vibration damping characteristic of the damper 30 of the FL wheel in a manner that depends on control purposes such as driving comfort and roll suppression of the vehicle body or making vibration damping characteristics of the dampers identical. The correlation therebetween is, as will be described later, determined in a manner that depends on control parameters (correlations among gains in gain matrix) used in calculation of unsprung control commands. The control parameters are appropriately set in a manner that depends on the vehicle type, vehicle speed, operation mode, and the like and may be fixed values or may be variable values that can be varied in a manner that depends on the vehicle speed and the like.

Further, the predetermined correlation is also applicable not only between the FR wheel and the FL wheel as described above, but also between the RR wheel and the RL wheel. In addition, the predetermined correlation may be applied between the front portion (FR wheel, FL wheel) and the rear portion (RR wheel, RL wheel) or between the vehicle wheels (FR and RL wheels or FL and RR wheels) in diagonal relationship to each other.

In this embodiment, the unsprung vibration control command calculation units 51 to 54 respectively multiply unsprung vibration levels of the wheels, which are input from the unsprung vibration determination units 41 to 44, by predetermined gains. Each of the unsprung vibration control command calculation units 51 to 54 selects a largest multiplication value from multiplication values obtained by respectively multiplying the unsprung vibration levels of the wheels by the predetermined gains, and generates an unsprung control command of the self-wheel on the basis of this.

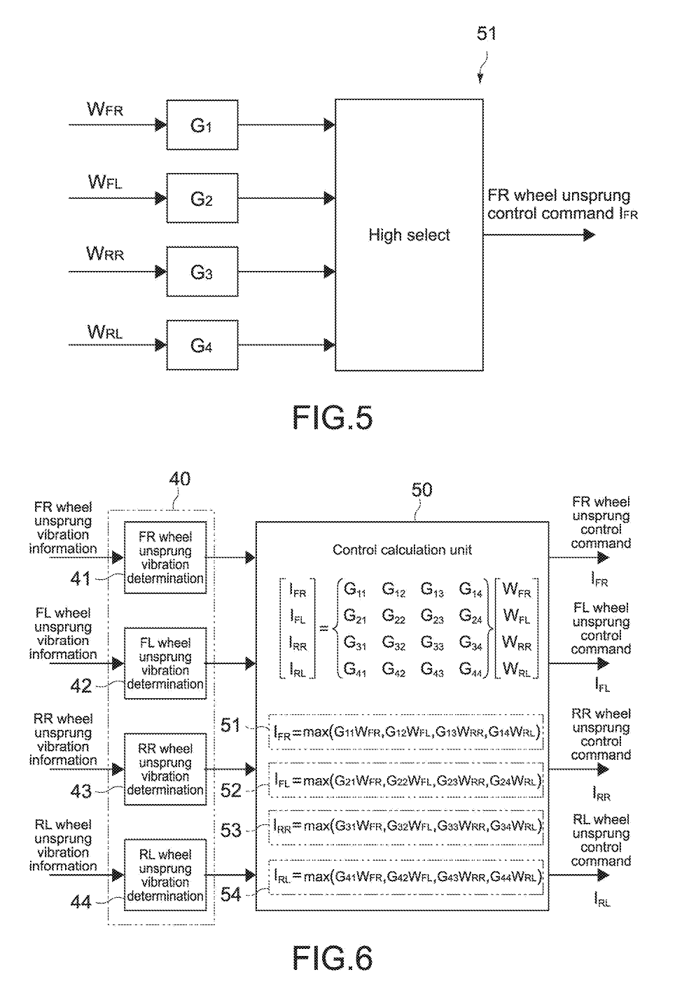

FIG. 5 is a block diagram for describing functions of the FR wheel unsprung control command calculation unit 51.

Assuming that the unsprung vibration levels (state signals) of the wheels that are output from the unsprung vibration determination units 41 to 44 are respectively indicated by W_{FR}, W_{FL}, W_{RR}, and W_{RL}, the FR wheel unsprung control command calculation unit 51 respectively multiplies the unsprung vibration levels W_{FR}, W_{FL}, W_{RR}, and W_{RL} by predetermined gains G₁, G₂, G₃, and G₄, selects (high select processing) a largest value from multiplication values thereof (G₁*W_{FR}, G₂*W_{FL}, G₃*W_{RR}, G₄*W_{RL}), and generates an FR wheel unsprung control command I_{FR} on the basis of the selected value.

Note that the gains G₁ to G₄ are arbitrary positive real numbers including 0 and appropriately set in a manner that depends on the vehicle type, specifications, and the like. Although the gains G₁ to G₄ may be fixed values, they may be variable values that can be manually or automatically changed in a manner that depends on the vehicle type, vehicle speed, operation mode, and the like as will be described later.

For example, in the case where outputs of the unsprung vibration determination units 41 to 44 are ON/OFF signals, by setting ON to be an output of 1 and OFF to be an output of 0, G₁ to G₄ are gains and at the same time values of the unsprung control commands. Then, it is only necessary to calculate the maximum value through the high select processing. In the case where the outputs of the unsprung vibration determination units 41 to 44 are signals that fluctuate, G₁ to G₄ are handled as gains as they are. Then, it is only necessary to calculate the maximum value through the high select processing.

As described above, both in the case where the outputs of the unsprung vibration determination units 41 to 44 are the ON/OFF signals and in the case where they are the signals that fluctuate, the FR wheel unsprung control command calculation unit 51 can cope with them with the same configuration.

The FL wheel unsprung control command calculation unit 52, the RR wheel unsprung control command calculation unit 53, and the RL wheel unsprung control command calculation unit 54 are also configured similarly to the FR wheel unsprung control command calculation unit 51 described above.

Here, provided that, although it is not normal mathematical notation, matrix notation of high select calculation is { }×[ ], the control unit 50 can be expressed as in FIG. 6. In the present specification, for the sake of easy understanding of the outline of the control, calculation expressions of the unsprung control commands unsprung control commands I_{FR}, I_{FL}, I_{RR}, and I_{RR} calculated in the unsprung control command calculation units 51 to 54 of the wheels are, for the sake of convenience, defined as follows.

I_{FR}=max(G₁₁W_{FR},G₁₂W_{FL},G₁₃W_{RR},G₁₄W_{RL}) (1)

I_{FL}=max(G₂₁W_{FR},G₂₂W_{FL},G₂₃W_{RR},G₂₄W_{RL}) (2)

I_{RR}=max(G₃₁W_{FR},G₃₂W_{FL},G₃₃W_{RR},G₃₄W_{RL}) (3)

I_{RL}=max(G₄₁W_{FR},G₄₂W_{FL},G₄₃W_{RR},G₄₄W_{RL}) (4)

For example, in Expression (1) above, max (G₁₁W_{FR}, G₁₂W_{FL}, G₁₃W_{RR}, G₁₄W_{RL}) means a maximum value selected from multiplication values (G₁₁W_{FR}, G₁₂W_{FL}, G₁₃W_{RR}, G₁₄W_{RL}) obtained by multiplying an unsprung vibration level by gains. The FR wheel unsprung control command calculation unit 51 generates this maximum value as the unsprung control command I_{FR} to the FR wheel.

Also regarding the FL wheel, RR wheel, and RL wheel unsprung control command calculation units 52 to 54, the unsprung control commands I_{FL}, I_{RR}, and I_{RL} to the FL wheel, RR wheel, and RL wheel are generated on the basis of Expressions (2) to (4) above.

Gains G₁₁, G₁₂, G₁₃, G₁₄, G₂₁, G₂₂, G₂₃, G₂₄, G₃₁, G₃₂, G₃₃, G₃₄, G₄₁, G₄₂, G₄₃, and G₄₄ that constitute a 4-by-4 G matrix are for causing the unsprung control commands to the wheels to have a predetermined correlation therebetween as in G₁ to G₄ above. The values of those gains G₁₁ to G₄₄ are not particularly limited and appropriately set in a manner that depends on vehicle feeling to be realized.

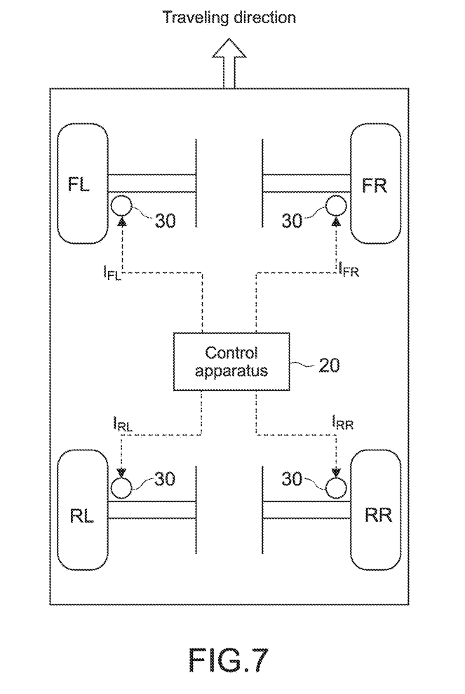

FIG. 7 is a schematic plan view showing wheels of a vehicle that travels in an arrow direction.

Unsprung control commands I_{FR}, I_{FL}, I_{RR}, and I_{RL} are respectively current values for setting the dampers 30 of the FR wheel, the FL wheel, the RR wheel, and the RL wheel to desired damping forces (damping characteristics). In this embodiment, as the values of those control commands become larger, they are adjusted to higher damping forces (damping characteristics). The unsprung control commands I_{FR}, I_{FL}, I_{RR}, and I_{RL} are typically output to the dampers 30 as the current values via a current control circuit, a pulse width modification circuit, and the like (not shown).

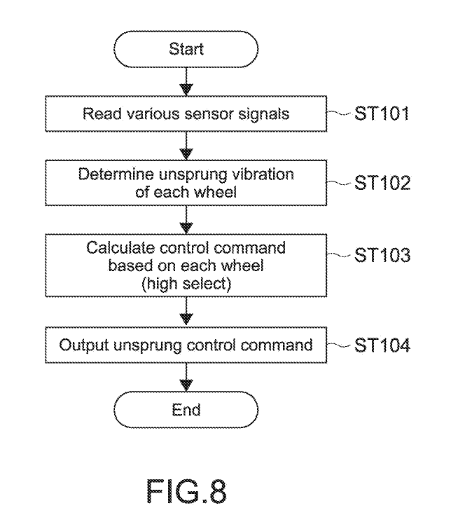

FIG. 8 shows an example of a control flow performed in the suspension control apparatus 20.

The signal generator 40 reads various sensor signals from the detector 10 and acquires unsprung vibration information items of the wheels (Step 101). Next, the signal generator 40 determines the acquired unsprung vibration information items of the wheels, generates state signals regarding unsprung vibrations with respect to the wheels, and outputs those state signals to the control unit 50 (Step 102).

Note that a determination method for the unsprung vibration information will be described later in detail.

Subsequently, the control unit 50 calculates unsprung control commands regarding the wheels on the basis of the unsprung vibration information items of the wheels. Specifically, the control unit 50 multiplies the input state signals of the wheels by the predetermined gains G₁₁ to G₄₄ (FIG. 6), generates unsprung control commands regarding the wheels I_{FR}, I_{FL}, I_{RR}, and I_{RL} by respectively performing high select calculation (Expressions (1) to (4) above) for the multiplication values in the unsprung control command calculation units 51 to 54, and outputs them to the dampers 30 (Steps 103 and 104). The unsprung control commands I_{FR}, I_{FL}, I_{RR}, and I_{RL} are generated by executing a program stored in a memory of the control unit 50.

As described above, the gains G₁₁ to G₄₄ that constitute the 4-by-4 G matrix are for causing the unsprung control commands to the wheels to have the predetermined correlation therebetween. In the case where the left and right wheels are symmetric to each other on each of front and rear sides, G₁₁=G₂₂, G₁₂=G₂₁, G₁₃=G₂₄, G₁₄=G₂₃, G₃₁=G₄₂, G₃₂=G₄₁, G₃₃=G₄₄, and G₃₄=G₄₃ are typically set. In addition to the above, G₁₁=G₂₂=G₃₃=G₄₄ may be set.

Note that the case where the left and right wheels are symmetric to each other refers to a case where vibration damping characteristics of the left and right wheels are equivalent when identical unsprung control commands are output to the left and right wheels.

The wheels that are targets of the cooperative control are not particularly limited. Typically, the wheels that are targets of the cooperative control are front or rear, left and right wheels or all the wheels. The purpose of the cooperative control is also not particularly limited. The driving comfort, a countermeasure against a roll, or the like is appropriately selected in a manner that depends on the vehicle type and the specifications. Hereinafter, the actions and effects of this embodiment will be described exemplifying some application examples including different gains G₁₁ to G₄₄.

### Application Example 1: Concurrent Control on Left and Right Wheels

For example, when the unsprung portion of the FL wheel vibrates, the unsprung and sprung portions of the FR wheel also largely vibrate as described above. Assuming that current values that are the unsprung control commands for the FL wheel and the FR wheel at this time are respectively I_{FL} (first control command) and I_{FR} (second control command), different actions can be obtained as follows due to a magnitude relationship among the gain G₁₁ (first gain), G₁₂ (second gain), G₂₁ (third gain), and G₂₂ (fourth gain).

Note that, although the front portion (front wheel) is described here, the same applies to the rear portion (rear wheel). Further, for the sake of easy understanding of the description, it is assumed that a 2-by-2 gain matrix is used in this example. Although the values of the gains (G₁₁ to G₂₂), the unsprung vibration levels (W_{FR} (first state signal), and the value of W_{FL} (second state signal)) are simple integers, they are not limited thereto as a matter of course.

(1-1: G₁₂<G₂₂)

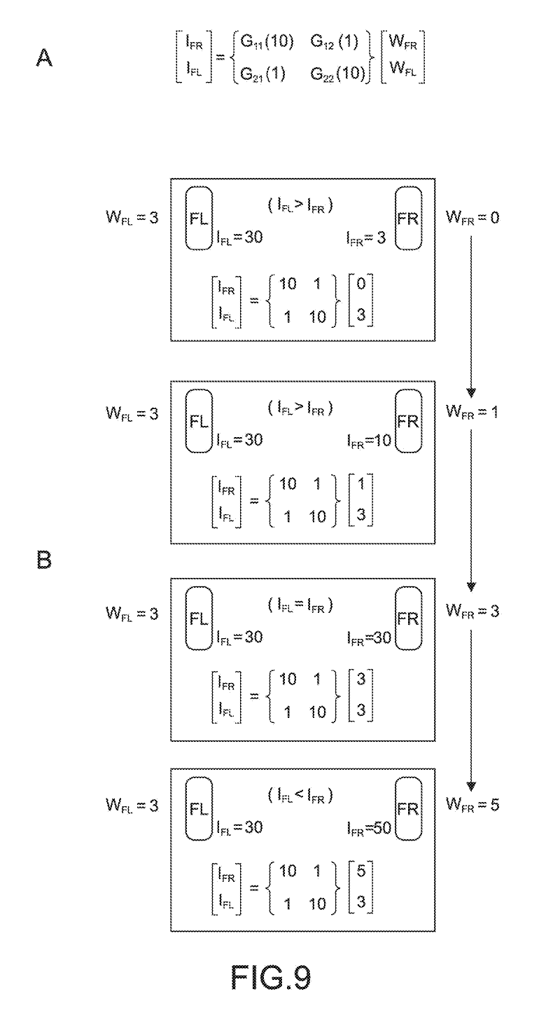

A of FIG. 9 shows an example of the gain matrix in this example (G₁₁=G₂₂=10, G₁₂=G₂₁=1). B of FIG. 9 shows changes in the unsprung control command of the wheels that are obtained when the unsprung vibration level W_{FL} of the FL wheel is made constant and the unsprung vibration level W_{FR} of the FR wheel increases in stages.

The FR wheel and FL wheel unsprung control command calculation units 51 and 52 respectively generate the unsprung control commands I_{FR} and I_{FL} to the FR wheel and the FL wheel through the above-mentioned high select processing.

Specifically, the FR wheel unsprung control command calculation unit 51 (first control command calculation unit) generates an unsprung control command I_{FR} (first control command) for electrically controlling a vibration damping characteristic of a damper 30 (first damper) mounted on the FR wheel on the basis of a maximum value selected from a multiplication value (G₁₁*W_{FR}) obtained by multiplying an unsprung vibration level W_{FR} (first state signal) of the FR wheel by a gain G₁₁ (first gain) and a multiplication value (G₁₂*W_{FL}) obtained by multiplying an unsprung vibration level W_{FL} (second state signal) of the FL wheel by a gain G₁₂ (second gain).

On the other hand, the FL wheel unsprung control command calculation unit 52 (second control command calculation unit) generates an unsprung control command I_{FL} (second control command) for electrically controlling a vibration damping characteristic of a damper 30 (second damper) mounted on the FL wheel on the basis of a maximum value selected from a multiplication value (G₂₁*W_{FR}) obtained by multiplying the unsprung vibration level W_{FR} (first state signal) of the FR wheel by the gain G₂₁ (third gain) and a multiplication value (G₂₂*W_{FL}) obtained by multiplying the unsprung vibration level W_{FL} (second state signal) of the FL wheel by a gain G₂₂ (fourth gain).

As a result, even when the unsprung vibration level W_{FR} of the FR wheel is 0, a significant unsprung control command corresponding to the value of the gain G₁₂ is generated with respect to the FR wheel as shown in B of FIG. 9. Thus, in this embodiment, when unsprung vibrations of at least one of the FR and FL wheels are detected, the unsprung control commands I_{FR} and I_{FL} are generated with respect to not only the wheel (FL wheel) that is vibrating, but also the wheel (FR wheel) that is not vibrating. With this, damping forces against unsprung vibrations of the both wheels are increased, induction of unsprung vibrations of the FR wheel due to a reaction force of damping control on the FL wheel is suppressed, and the influence of the reaction force on the FR wheel is reduced.

When unsprung vibrations occur in the FR wheel, the unsprung control command I_{FR} having magnitude proportional to the value of the gain G₁₂ as an increase amount of the unsprung vibration level W_{FR} of the FR wheel is generated through the high select processing in the FR wheel unsprung control command calculation unit 51 as shown in B of FIG. 9.

In this example, in the case where the unsprung vibration level W_{FR} of the FR wheel is lower than the unsprung vibration level W_{FL} of the FL wheel, a correlation of I_{FR}<I_{FL} is obtained due to a correlation of G₁₂<G₂₂. With this, magnitude of unsprung vibrations of the FL wheel is large and magnitude of unsprung vibrations of the FR wheel is small, and hence unsprung vibrations of the both wheels can be suppressed by using minimum necessary damping forces for both the FR and FL wheels while suppressing deterioration of the driving comfort to the minimum. A difference between G₂₂ and G₁₂ is not particularly limited. For suppressing unsprung vibrations of the FR wheel, it is only necessary that the value of I_{FR} be not 0 (it is only necessary that gain G₁₂ be not 0).

When the unsprung vibration level W_{FR} of the FR wheel is equal to the unsprung vibration level W_{FL} of the FL wheel, unsprung control commands I_{FR} and I_{FL} having identical magnitude are generated with respect to the both wheels as results of the high select processing in the unsprung control command calculation units 51 and 52 (B of FIG. 9). Therefore, equivalent damping control is performed on each of the both wheels vibrating at the identical vibration level, and hence deterioration of the driving comfort is prevented.

On the other hand, when the unsprung vibration level W_{FR} of the FR wheel becomes higher than the unsprung vibration level W_{FL} of the FL wheel, the magnitude of the unsprung control commands to the wheels is inverted in comparison with the above-mentioned example and a correlation of I_{FR}>I_{FL} is obtained as results of the high select processing in the unsprung control command calculation units 51 and 52. It means that, in this example, equivalent control can be performed on each of the wheels both in the case where the vibration level of the FL wheel is higher than the vibration level of the FR wheel and the case where the vibration level of the FR wheel is higher than the vibration level of the FL wheel.

(1-2: G₁₂>G₂₂)

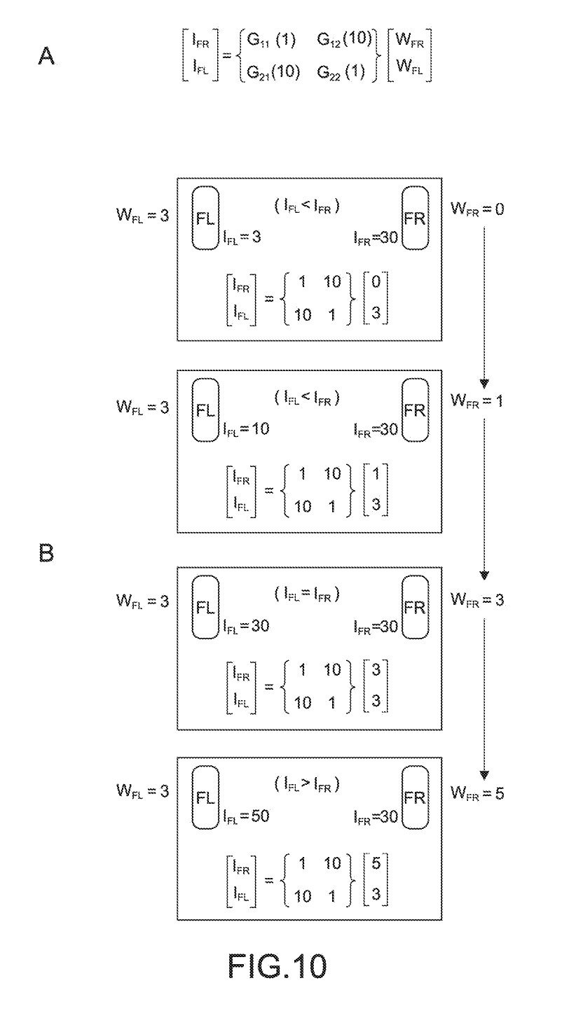

A of FIG. 10 shows an example of the gain matrix in this example (G₁₁=G₂₂=1, G₁₂=G₂₁=10). B of FIG. 10 shows changes in the unsprung control commands for the wheels that are obtained when the unsprung vibration level W_{FL} of the FL wheel is made constant and the unsprung vibration level W_{FR} of the FR wheel increases in stages.

The FR wheel and FL wheel unsprung control command calculation units 51 and 52 generate unsprung control commands I_{FR} and I_{FL} to the FR wheel and the FL wheel through the above-mentioned high select processing. As a result, when the unsprung vibration level of the FR wheel is lower than the unsprung vibration level of the FL wheel, unsprung control commands satisfying a relationship of I_{FR}>I_{FL} are generated.

Under the condition that the unsprung portion of the FL wheel is largely vibrating and the unsprung portion of the FR wheel is only slightly vibrating, a large damping force cannot be generated in the FR wheel having a small damper speed even when the same current values are output to the left and right wheels. Therefore, vibrations of the sprung portion are easily transmitted to the FR wheel, and roll behaviors easily occur.

In view of this, by establishing a correlation of G₁₂>G₂₂ between G₁₂ and G₂₂, the movement of the FR wheel can be largely suppressed. With this, the roll behaviors can be easily suppressed. A difference between G₁₂ and G₂₂ is not particularly limited. For suppressing unsprung vibrations of the FL wheel, it is only necessary that the value of I_{FL} be not 0 (it is only necessary that the gain G₂₂ not be 0).

Note that, when the unsprung vibration level of the FR wheel is higher than the unsprung vibration level of the FL wheel, the magnitude of the unsprung control commands to the wheels is inverted in comparison with the above-mentioned example, and a correlation of I_{FR}<I_{FL} is obtained. It means that, also in this example, equivalent control can be performed on each of the wheels both in the case where the vibration level of the FL wheel is higher than the vibration level of the FR wheel and in the case where the vibration level of the FR wheel is higher than the vibration level of the FL wheel.

Further, when the unsprung vibration levels of the both wheels are identical, unsprung control commands satisfying a relationship of I_{FR}=I_{FL} are generated as in the above-mentioned example.

(1-3: G₁₂=G₂₂)

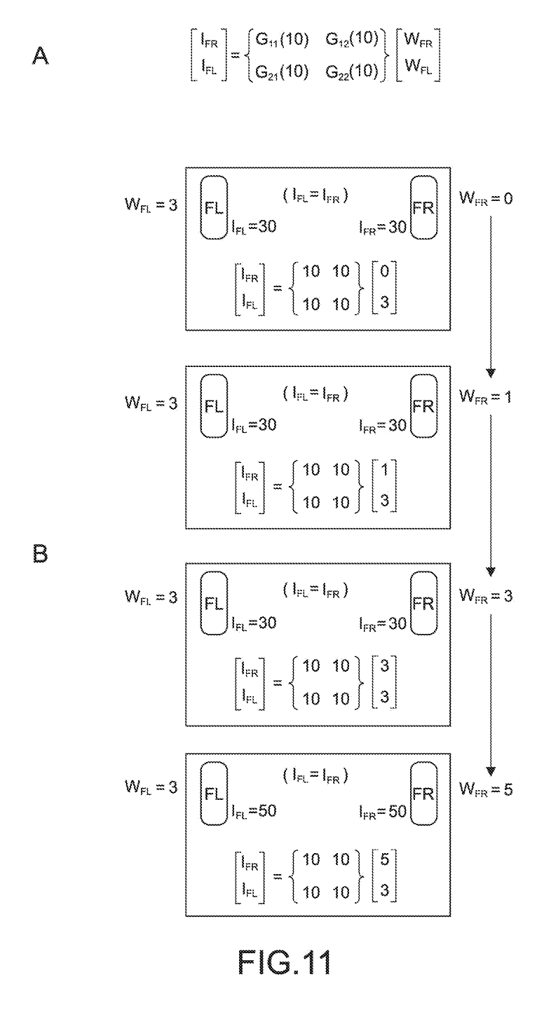

A of FIG. 11 shows an example of the gain matrix in this example (G₁₁=G₁₂=G₂₁=G₂₂=10). B of FIG. 11 shows changes in the unsprung control commands for the wheels that are obtained when the unsprung vibration level W_{FL} of the FL wheel is made constant and the unsprung vibration level W_{FR} of the FR wheel increases in stages.

In this example, G₁₂ and G₂₂ have a correlation of G₁₂=G₂₂, and hence a correlation of I_{FL}=I_{FR} is obtained irrespective of the unsprung vibration level of the FR wheel. With this, it is possible to provide vehicle behaviors similar to those of a conventional damper that is not of the damping force variable type, which are familiar to many ordinary users.

Further, in this example, the magnitude of the unsprung control command I_{FR} and I_{FL} for the wheels is calculated on the basis of a largest value among the unsprung vibration levels of the wheels.

As described above, when the unsprung portion of the FL wheel vibrates, a current value that is not zero is applied as a current command of the FR wheel. Here, there are advantages if magnitude of current value is smaller than, equal to, or larger than a current command of the FL wheel.

By mutually and cooperatively controlling the damper of the self-wheel and the damper of the wheel that is opposite thereto in the left- and right-hand directions in this manner, it becomes possible to efficiently suppress unsprung vibrations of those wheels and suppresses a roll. Thus, it is possible to realize desired vehicle feeling. Further, the unsprung control commands to the wheels are concurrently generated and output, and hence it is possible to concurrently perform unsprung control on the wheels. With this, deterioration of the vehicle feeling caused due to a control time lag in the wheels can be prevented.

In particular, in this embodiment, control algorithms for the left and right wheels are basically set to be the same (symmetric) (specifically, setting is made such that the gains G₁₁ and G₂₂ are identical to each other and the gains G₁₂ and G₂₁ are identical to each other). With this, unification is achieved such that an unsprung control command of one wheel and an unsprung control command of the other wheel realize predetermined cooperative control together. Thus, it becomes possible to stably realize desired vehicle feeling.

Further, in generation of the unsprung control command I_{FR} and I_{FL}, the maximum value selected from the multiplication values obtained by respectively multiplying the unsprung vibration levels W_{FR} and W_{FL} of the wheels by the predetermined gains G₁₁ to G₂₂ is used. Thus, it is possible to rapidly stabilize the wheel in which unsprung vibrations are generated and efficiently control vibrations of the other wheels in a manner that depends on the purposes such as the driving comfort, roll suppression, and vehicle feeling.

### Application Example 2: Concurrent Control of all Wheels

When the unsprung portion of the FL wheel vibrates, a roll is excited and a diagonal movement in which the RR wheel and the FL wheel that are diagonal to each other are largely moved is also relatively largely excited as a sprung movement, though it depends on the position of the center of weight of the vehicle. Note that, when only the FL wheel vibrates, a bounce and a pitch are not easily excited in comparison with other sprung vibrations.

Also considering such a condition, it is favorable to concurrently control all the wheels. As one of methods therefor, the following example is conceivable. Also here, it is assumed that the wheel whose unsprung portion is vibrating is the FL wheel. Further, for the sake of easy understanding of the description, it is assumed that the values of the gains (G₁₁ to G₄₄) and the values of the unsprung vibration levels (W_{FR}, W_{FL}, W_{RR}, and W_{RL}) are simple integers also in this example. However, they are not limited thereto as a matter of course. In reality, the gains are set in view of the position of the center of weight of the vehicle body, a tread width in the front and rear wheels, a difference in the lever ratio, and the like.

(2-1: G₁₂=G₂₂, G₃₂=G₄₂)

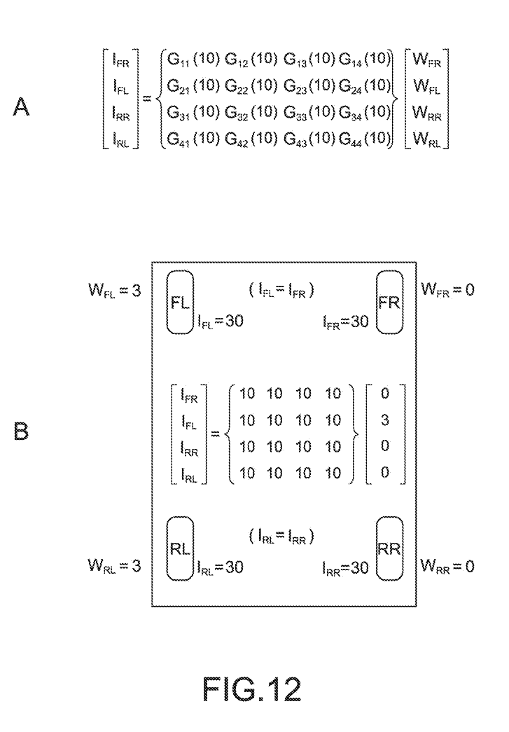

A of FIG. 12 shows an example of the gain matrix in this example. B of FIG. 12 shows examples of the magnitude of the unsprung control commands for the wheels.

The FR wheel and FL wheel unsprung control command calculation units 51 and 52 respectively generate unsprung control commands I_{FR} and I_{FL} to the FR wheel and the FL wheel in accordance with Expressions (1) and (2) above.

That is, the FR wheel unsprung control command calculation unit 51 generates a first unsprung control command I_{FR} on the basis of a maximum value selected from a multiplication value (G₁₁*W_{FR}) obtained by multiplying an unsprung vibration level W_{FR} (first state signal) of the FR wheel by a gain G₁₁ (first gain), a multiplication value (G₁₂*W_{FL}) obtained by multiplying an unsprung vibration level W_{FL} (second state signal) of the FL wheel by a gain G₁₂ (second gain), a multiplication value (G₁₃*W_{RR}) obtained by multiplying an unsprung vibration level W_{RR} (third state signal) of the RR wheel by a gain G₁₃ (fifth gain), and a multiplication value (G₁₄*W_{RL}) obtained by multiplying an unsprung vibration level W_{RL} (fourth state signal) of the RL wheel by a gain G₁₄ (sixth gain).

On the other hand, the FL wheel unsprung control command calculation unit 52 generates a second unsprung control command I_{FL} on the basis of a maximum value selected from a multiplication value (G₂₁*W_{FR}) obtained by multiplying the unsprung vibration level W_{FR} (first state signal) of the FR wheel by G₂₁ (third gain), a multiplication value (G₂₂*W_{FL}) obtained by multiplying the unsprung vibration level W_{FL} (second state signal) of the FL wheel by the gain G₂₂ (fourth gain), a multiplication value (G₂₃*W_{RR}) obtained by multiplying the unsprung vibration level W_{RR} (third state signal) of the RR wheel by a gain G₂₃ (seventh gain), and a multiplication value (G₂₄*W_{RL}) obtained by multiplying the unsprung vibration level W_{RL} (fourth state signal) of the RL wheel by a gain G₂₄ (eighth gain).

Note that the RR wheel and RL wheel unsprung control command calculation units 53 and 54 respectively generate unsprung control commands I_{RR} and I_{RL} to the RR wheel and the RL wheel in accordance with Expressions (3) and (4) above.

In accordance with this example, correlations of I_{FL}=I_{FR} and I_{RL}=I_{RR} are established between I_{FL} and I_{FR} and between I_{RL} and I_{RR} due to the correlations among the gains G₁₁ to G₄₄. It aims at making feeling of suppressing unsprung vibrations similar to that of the conventional damper that is not of the damping force variable type and concurrently suppressing a roll as well as diagonal sprung behaviors. In accordance with this example, it is possible to provide the vehicle behaviors similar to those of the conventional damper.

Note that, although I_{FL} and I_{RL} are identical values in this example, they may be values different from each other.

(2-2: G₁₂<G₂₂, G₃₂>G₄₂)

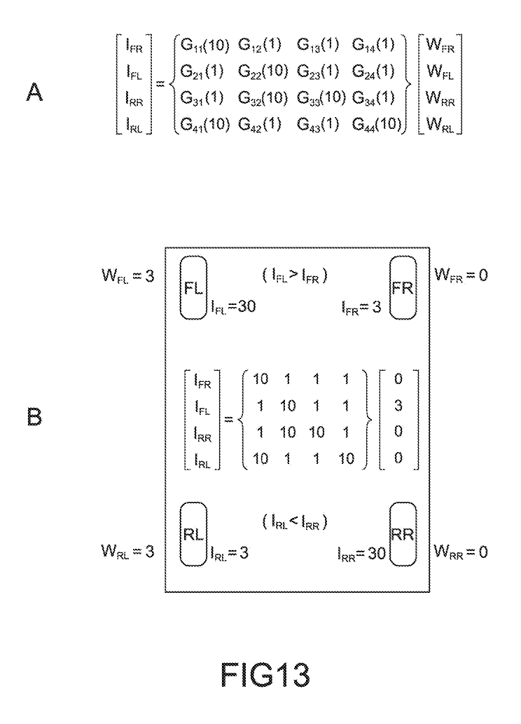

A of FIG. 13 shows an example of the gain matrix in this example. B of FIG. 13 shows examples of the magnitude of the unsprung control commands for the wheels.

In accordance with this example, correlations of I_{FL}>I_{FR} and I_{RL}<I_{RR} are established between I_{FL} and I_{FR} and between I_{RL} and I_{RR} due to the correlations among the gains G₁₁ to G₄₄. It aims at suppressing only unsprung vibrations of the front portion and suppressing diagonal behaviors of the sprung portion without deteriorating the driving comfort. In this case, the value of I_{RL} may be 0.

(2-3: G₁₂>G₂₂, G₄₂≦G₃₂)

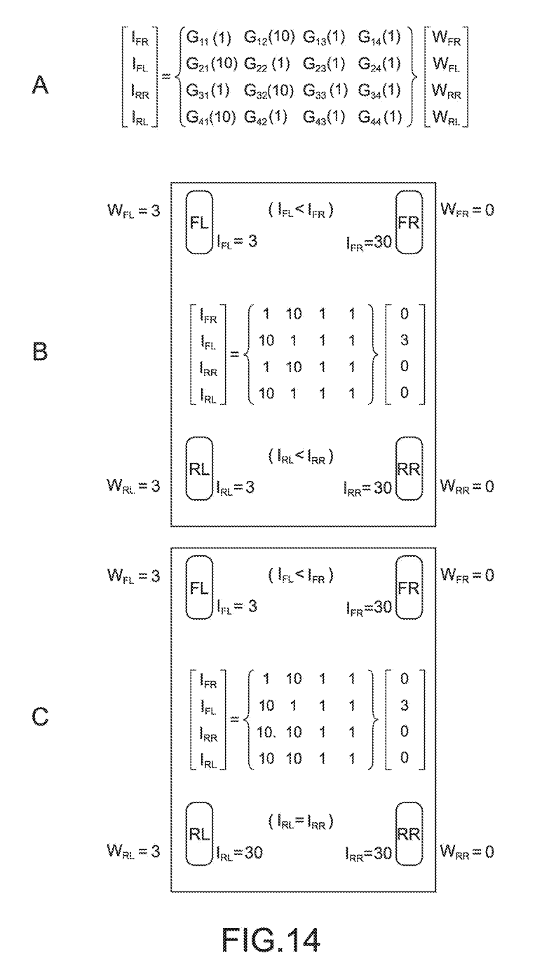

A of FIG. 14 shows an example of the gain matrix in this example. B of FIG. 14 shows examples of the magnitude of the unsprung control commands for the wheels.

In accordance with this example, correlations of I_{FL}<I_{FR} and I_{RL}≦I_{RR} are established between I_{FL} and I_{FR} and between I_{RL} and I_{RR} due to the correlations among the gains G₁₁ to G₄₄. With this, it is possible to preferentially suppress a roll and diagonal behaviors of the sprung portion. Also in this case, the value of I_{RL} may be 0.

Examples of the value of the gain matrix and magnitude of the control commands for the wheels, with which the correlations of I_{FL}<I_{FR} and I_{RL}=I_{RR} are obtained, are shown in C of FIG. 14.

In this example, although a difference in the magnitude between the current commands of the front and rear portions cannot be easily compared due to differences in the lever ratio and the shared load, for example, a current command having a level that can suppress unsprung vibrations can be set as I_{FL} and a significantly large current command can be set to the other wheels (although I_{RL}<I_{RR} may be established or I_{RL}=I_{RR} may be established for the rear portion, the gains G₃₁, G₃₂, G₄₁, and G₄₂ are set such that the value of each of them becomes larger, for example, as shown in C of FIG. 14). With this, a state in which three points of four support points of the sprung portions are restricted is obtained. Consequently, it becomes difficult for the sprung portion of the FL wheel that is the vibrating wheel to be moved, and it becomes possible to keep the vehicle body flat.

As described above, by mutually and cooperatively controlling not only the damper of the self-wheel and the damper of the wheel opposite thereto in the left- and right-hand directions, but also the other wheels in diagonal relationship to them, it becomes possible to efficiently suppress sprung vibrations of the wheels. Thus, it is possible to further improve the vehicle feeling.

Further, the unsprung control commands to the wheels are concurrently generated and output, and hence it is possible to concurrently perform unsprung control on the wheels. With this, deterioration of the vehicle feeling caused due to a control time lag in the wheels can be prevented.

Note that, when the unsprung portions of the left and right wheels vibrate at the same magnitude as in Application Example 1, the unsprung control commands for the left and right wheels have the same magnitude in each of the front portion and the rear portion.

Regarding this application example, the case where the FL wheel vibrates has been described. In the case where the wheel left-right symmetric to it vibrates as in Application Example 1, it is only necessary to consider it inversely.

Further, the main vibrating wheel is the front wheel in the above description. In the case where the main vibrating wheel is the rear wheel, it is only necessary to set the gains G₃₃, G₃₄, G₄₃, and G₄₄ or correlations obtained by adding the gains G₁₃, G₁₄, G₂₃, and G₂₄ to them.

As described above, by mutually and cooperatively controlling not only the damper of the self-wheel and the damper of the wheel opposite thereto in the left- and right-hand directions, but also the dampers of the wheels in diagonal relationship, it becomes possible to efficiently suppress unsprung vibrations or sprung vibrations of those wheels. Thus, it is possible to realize desired vehicle feeling.

### Second Embodiment

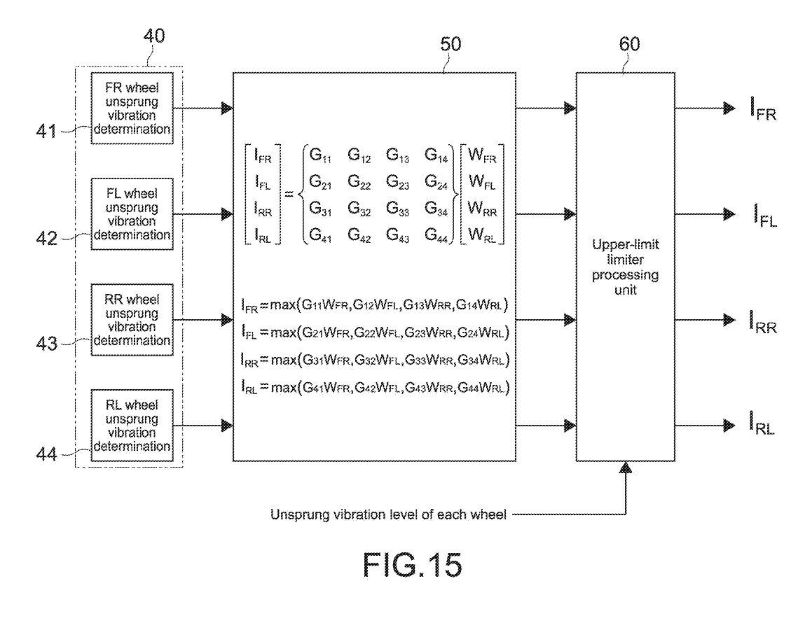

FIG. 15 is a schematic block diagram of a suspension control apparatus according to another embodiment of the present invention.

As described above, in accordance with Application Example 1 (concurrent control on left and right wheels) and Application Example 2 (concurrent control of all wheels), vibrations (unsprung vibrations or sprung vibrations) of each wheel that is a target are cooperatively controlled. Thus, vibrations of each wheel can be efficiently suppressed.

By the way, in Application Examples 1 and 2 above, there is a case where the control commands of the wheels other than the wheel whose unsprung portion is vibrating is set to be large in order to suppress movements of the sprung portions. In the case where such control is applied, a large control command is selected in each wheel, and there is a fear that a disadvantage of deterioration of the driving comfort may be apparent.

Therefore, in this embodiment, an upper-limit limiter processing unit 60 (limiter processing unit) is further provided at a subsequent stage of the control unit 50 as shown in FIG. 15.

The upper-limit limiter processing unit 60 is configured to be capable of individually setting, with respect to each control command, an upper-limit limiter value in a direction in which the damping force characteristic increases, in a manner that depends on the magnitude of unsprung vibrations of each wheel. With this, it becomes possible to prevent the control command from being unnecessarily excessively large. Or, it becomes possible to prevent the control command from being a control command (current command) equal to or larger than a current value that can be output.

As shown in FIG. 15, unsprung vibration levels of the wheels may be input into the upper-limit limiter processing unit 60. In this case, the upper-limit limiter processing unit 60 is configured to monitor magnitude of unsprung vibrations (vibration level) of each wheel and gradually reduce a control command to a wheel whose unsprung vibrations become larger, in a direction in which the damping force characteristic decreases, as those unsprung vibrations become larger. With this, it is possible to prevent the control commands for all the wheels from being unnecessarily large if the cooperatively controlled wheels all have high unsprung vibration levels.

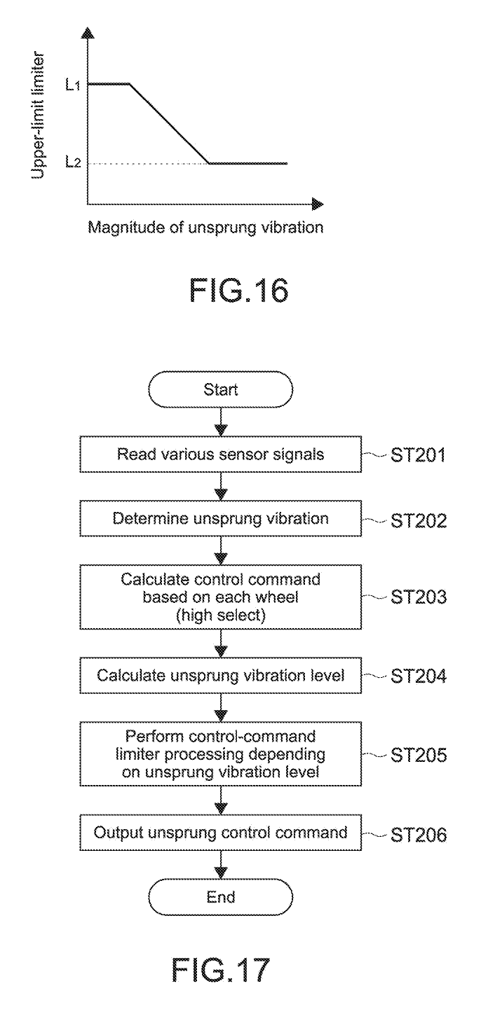

FIG. 16 is a diagram showing an example of a relationship between the magnitude of unsprung vibrations and the upper-limit limiter value of the unsprung control command. L₁ and L₂ on the vertical axis are each magnitude (current value) of the unsprung control command. For example, L₁ indicates a level necessary for giving a large damping force even if the unsprung vibration level is low, for the purpose of the roll suppression. L₂ indicates a minimum level of a damping force necessary for suppressing unsprung vibrations.

In the illustrated example, when unsprung vibrations are within a certain range, the upper-limit limiter value is linearly reduced. By setting a level for starting the reduction of the upper limit value in this manner, it is possible to ensure desired vehicle behaviors while preventing deterioration of the vehicle feeling. The characteristic for reducing the upper-limit limiter value is not limited to be linear, and may be step-wise or may be parabolic.

Note that the upper-limit limiter processing unit 60 is not limited to the example in which it is mounted on the subsequent stage of the control unit 50, and it may be incorporated in the control unit 50, for example. Further, the unsprung vibration level of each wheel that is loaded in the upper-limit limiter processing unit 60 may be vehicle wheel speed information of each wheel.

FIG. 17 shows an example of a control flow performed in the suspension control apparatus of this embodiment.

The signal generator 40 reads various sensor signals from the detector 10 and acquires unsprung vibration information items of the wheels (Step 201). Next, the signal generator 40 determines the acquired unsprung vibration information items of the wheels, respectively generates state signals regarding unsprung vibrations with respect to the wheels, and outputs those state signals to the control unit 50 (Step 202).

Subsequently, the control unit 50 respectively multiplies the predetermined gains G₁₁ to G₄₄ (FIG. 6) by the input state signals of the wheels, and performs high select calculation on the obtained multiplication values (Step S203).

The upper-limit limiter processing unit 60 calculates or acquires unsprung vibration levels of the wheels (Step 205). After performing upper-limit limiter processing of control commands that is depending on the unsprung vibration levels, the upper-limit limiter processing unit 60 outputs unsprung control commands regarding the wheels (Step 206).

### Third Embodiment

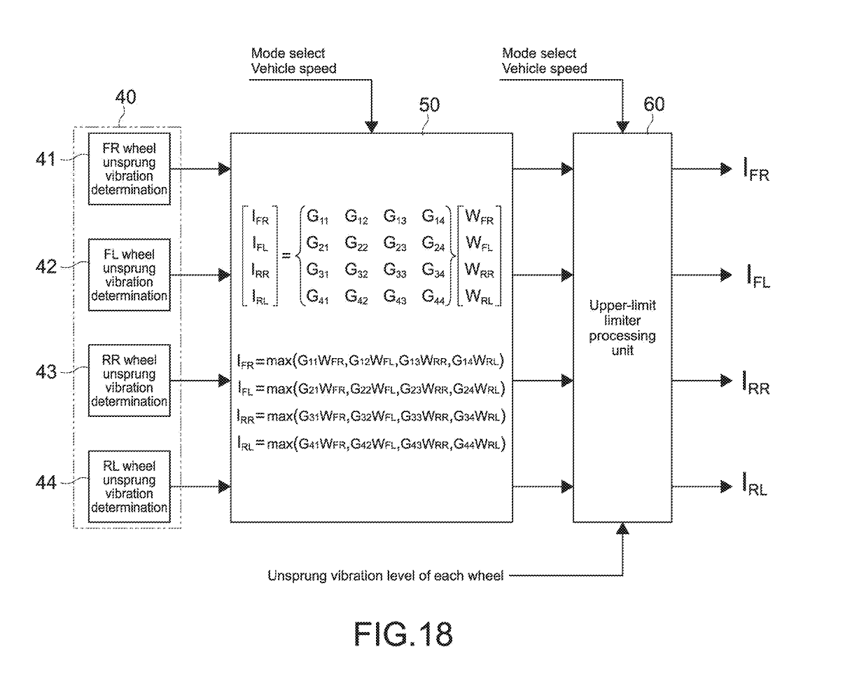

FIG. 18 is a schematic block diagram of a suspension control apparatus according to another embodiment of the present invention.

Desired vehicle feeling depends on each vehicle. In addition, even desired vehicle feeling of a single vehicle varies in a manner that depends on the vehicle speed. Further, mode select of soft, normal, sport, and the like is often prepared for some vehicles each installing damping force variable dampers. In such a case, the desired vehicle feeling varies in a manner that depends on the mode select. Therefore, by varying the mode of cooperative control on unsprung vibrations in a manner that depends on the vehicle speed or the operation mode, it becomes possible to satisfy various needs.

Therefore, the suspension control apparatus of this embodiment includes a mode detector that detects the mode select and a vehicle speed detector that detects the vehicle speed of the vehicle. The control unit 50 is configured to variably control the values of the gains G₁₁ to G₄₄ in a manner that depends on the detected operation mode or vehicle speed. With this, it becomes possible to obtain comfortable vehicle feeling in a manner that depends on the operation mode or the vehicle speed.

The operation mode is determined on the basis of, for example, an output of a mode change switch mounted on a driver's seat.

The vehicle speed is typically calculated on the basis of outputs of the vehicle wheel speed sensors mounted on the wheels. The vehicle speed detector is constituted of a calculation apparatus (not shown). This calculation apparatus may be configured in a part of the suspension control apparatus (e.g., within the signal generator 40) or may be configured within a control apparatus (e.g., brake control apparatus) different from the suspension control apparatus.

As shown in FIG. 18, the acquired operation mode information and vehicle speed information are input in at least one of the control unit 50 and the upper-limit limiter processing unit 60. The control unit 50 changes the gains G₁₁ to G₄₄ that determine the correlations among the unsprung control commands I_{FR}, I_{FL}, I_{RR}, and I_{RL}, on the basis of the operation mode information or the vehicle speed information. The upper-limit limiter processing unit 60 changes the upper limit values of the unsprung control commands on the basis of the operation mode information or the vehicle speed information.

In this embodiment, the configuration in which the settings of the control unit 50 and the upper-limit limiter processing unit 60 are changed referring to both of the operation mode and the vehicle speed is employed. However, a reference may be made to only either one of the operation mode and the vehicle speed. As setting parameters such as the gains and the limiter values, for example, fixed values depending on the modes are set in the case of depending on the operation mode and they are changed in a manner that depends on the vehicle speed in the case of depending on the vehicle speed. For example, when the sport mode is selected or as the vehicle speed increases, control parameters for suppression of the roll behaviors that is a main purpose are set. When the soft mode is selected or as the vehicle speed decreases, control parameters for suppression of unsprung vibrations that is a main purpose are set.

The operation mode information and the vehicle speed information may be input into the signal generator 40 instead of or in addition to the control unit 50 or the upper-limit limiter processing unit 60. In this case, the signal generator 40 generates the state signals regarding unsprung vibrations of the wheels on the basis of the operation mode or the vehicle speed. With this, the unsprung control commands reflecting the operation mode information and the vehicle speed information can be generated in the control unit 50.

When the speed of the vehicle is within a first speed range, the control unit 50 may be configured to set the gain G₁₂ (second gain) to a value smaller than the gain G₂₂ (fourth gain) and reduce a difference between the gains G₁₂ (second gain) and G₂₂ (fourth gain) as the vehicle speed increases.

On the other hand, when the speed of the vehicle is within a second speed range equal to or higher than the first speed range, the control unit 50 may be configured to set the gain G₁₂ (second gain) to a value equal to or larger than the gain G₂₂ (fourth gain) and increase a difference between the gain G₁₂ (second gain) and the gain G₂₂ (fourth gain) as the vehicle speed increases.

With this, the vehicle feeling can be changed from that given mainly for the driving comfort to that given mainly for a countermeasure against a roll as the vehicle speed increases.

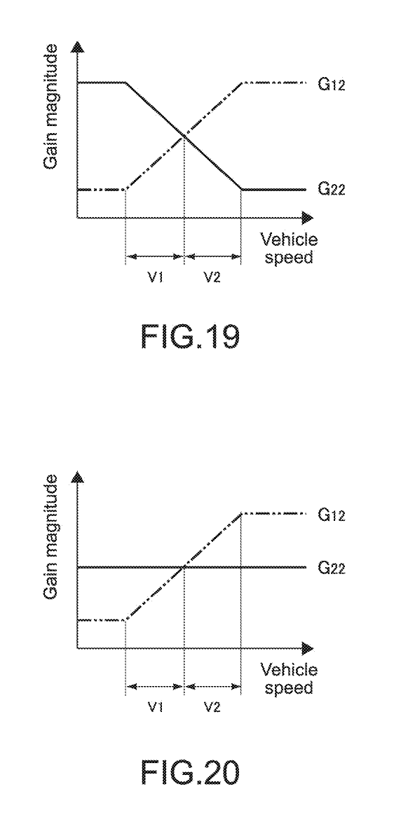

An example of the variable control on the gains G₁₂ and G₂₂ will be shown in FIG. 19. The gain G₁₂ is initially set to a value smaller than the gain G₂₂.

In the variable control example shown in FIG. 19, the control unit 50 is configured to increase the value of the gain G₁₂ while reducing the value of the gain G₂₂ as the vehicle speed increases. With this, when the speed of the vehicle is within a first speed range V1, a difference between the gains G₁₂ and G₂₂ becomes smaller. When the speed of the vehicle is within a second speed range V2, the magnitude relationship between the gains G₁₂ and G₂₂ is inverted and the difference between the gains G₁₂ and G₂₂ increases as the vehicle speed increases.

Either one of the gains G₁₂ and G₂₂ may be fixed and the other one may be changed. In the variable control example shown in FIG. 20, the control unit 50 is configured to fix the gain G₂₂ and increase the gain G₁₂ as the vehicle speed increases.

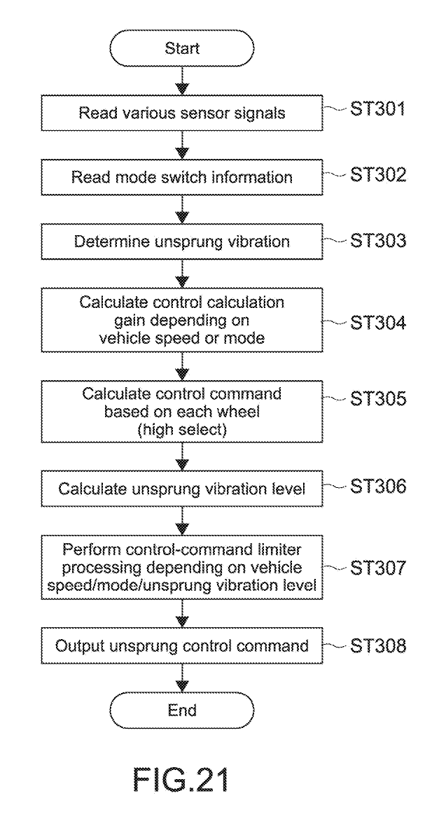

FIG. 21 shows an example of a control flow performed in the suspension control apparatus of this embodiment.

The signal generator 40 reads, from the detector 10, various sensor signals and operation mode information, and acquires unsprung vibration information of the wheels (Steps 301 and 302). Next, the signal generator 40 determines the unsprung vibration information of the wheels on the basis of those information items, generates state signals regarding unsprung vibrations with respect to the wheels, and outputs those state signals to the control unit 50 (Step 303).

Subsequently, the control unit 50 multiplies the input state signals of the wheels by predetermined gains G₁₁ to G₄₄ set in a manner that depends on the vehicle speed or the operation mode, and calculates unsprung vibration levels of the wheels by performing high-select calculation on the obtained multiplication values (Steps S304 to 306).

The upper-limit limiter processing unit 60 calculates or acquires unsprung vibration levels of the wheels, the vehicle speed, and the operation mode and outputs the unsprung control commands regarding the wheels after performing upper-limit limiter processing on the control commands that is depending on them (Steps 307 and 308).

### Fourth Embodiment

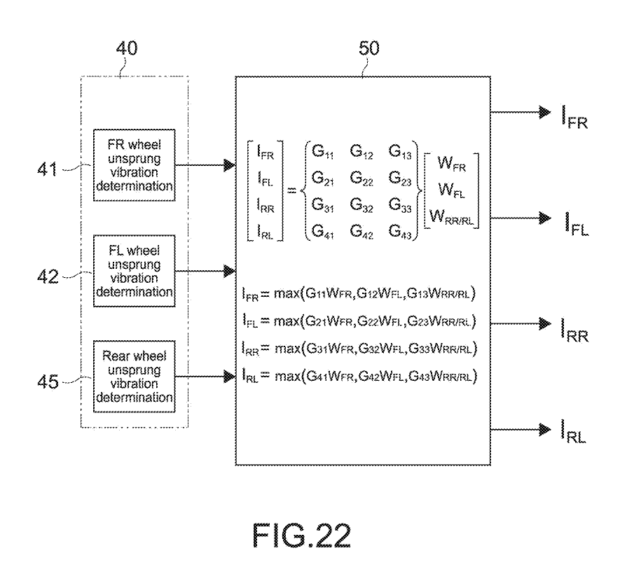

FIG. 22 is a schematic block diagram of a suspension control apparatus according to another embodiment of the present invention.

For cooperatively controlling unsprung vibrations of a plurality of wheels, it is ideal that unsprung vibration information items of all wheels of a vehicle be obtained. There can be a case where, in some arrangements of sensors, only unsprung vibration information common to left and right portions in either one of the front and rear portions, for example, cannot be obtained. For example, there is a case where the suspension displacement sensors and the unsprung acceleration sensors are not attached to both of the left and right wheels in the rear portion and the sprung acceleration sensor is mounted only on the center between the rear left and right wheels. In this case, by extracting unsprung vibration components from the sprung acceleration sensor and handling this information as unsprung vibration information common to the RR wheel and the RL wheel, it is possible to realize unsprung cooperative control similar to that described above.

In this embodiment, as shown in FIG. 22, the signal generator 40 includes a rear wheel unsprung vibration determination unit 45. The rear wheel unsprung vibration determination unit 45 acquires unsprung vibration information common to the RR wheel and the RL wheel, determines an unsprung vibration state of those rear wheels, and generates a state signal (W_{RR/RL}) common to the rear wheels. The control unit 50 has a 4-by-3 G matrix for calculating unsprung control commands (I_{RR} and I_{RL}) of the rear wheels from the common state signal (W_{RR/RL}) of the rear wheels. The unsprung control commands of the rear wheels may vary in a manner that depends on desired vehicle feeling. In this case, correlations among gains G₃₁ to G₃₃ and G₄₁ to G₄₃ are, for example, determined in a manner that depends on that purpose.

Note that an unsprung control command (I_{RR/RL}) common to the rear wheels may be generated and the G matrix in this case is formed of 3 rows by 3 columns.

### Fifth Embodiment

[Details of Signal Generator]

Subsequently, the signal generator 40 will be described in detail.

(Acquisition of Unsprung Vibration Information)

First of all, an acquisition method for the unsprung vibration information will be described. The signal generator 40 generates, on the basis of unsprung vibration information items acquired from the detector 10, state signals regarding unsprung vibrations of the wheels (FIG. 3).

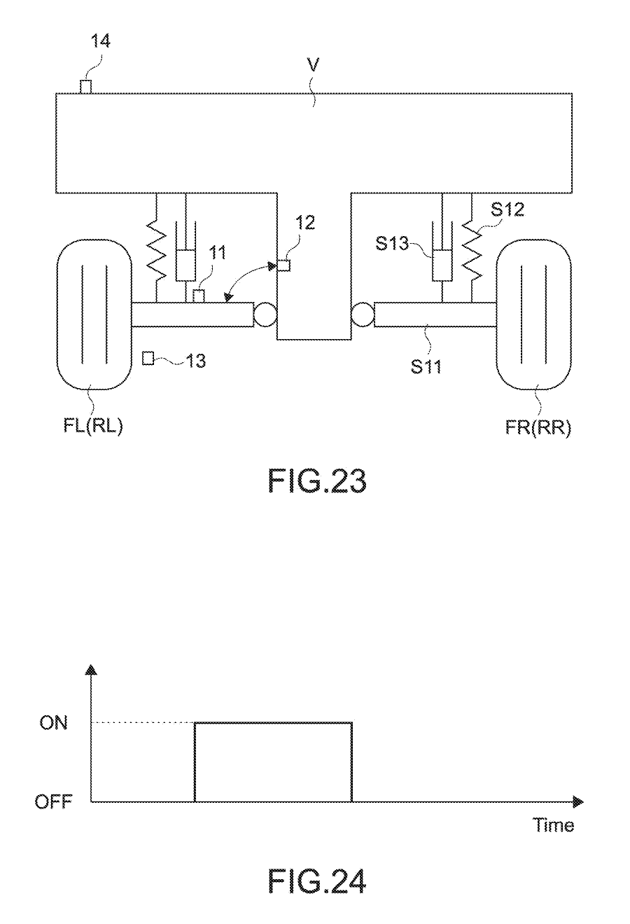

FIG. 23 shows various sensors capable of acquiring unsprung vibration information items of vehicle wheels and an arrangement example thereof. Note that, in FIG. 23, portions corresponding to those of FIG. 1 will be denoted by identical symbols and descriptions thereof will be omitted.

Examples of the sensors capable of acquiring the unsprung vibration information of the vehicle wheel include an unsprung acceleration sensor 11, a displacement sensor 12, a vehicle wheel speed sensor 13, and a sprung acceleration sensor 14.

The unsprung acceleration sensor 11 is mounted on a suspension arm S11, for example. Since the unsprung acceleration sensor 11 directly measures unsprung vibration information, a detection value of the sensor as it is or an integral value thereof can be used as the unsprung vibration information.

Note that, strictly speaking, vibrations of the sprung portions and road components are also significantly added to the detection signal and the detection signal further contains vibrations, high-frequency noise, and the like of the front and rear left and right portions of the suspension. In view of this, the S/N that is the unsprung vibration information is further enhanced if the detection signal passes through a band-pass filter (BPF) that allows an unsprung resonant frequency band to pass therethrough.

The displacement sensor 12 is mounted on between the vehicle body V and the suspension arms S11, for example. Since the displacement sensor 12 measures a relative displacement (suspension displacement) between the sprung and unsprung portions, vibration components of both of the sprung and unsprung portions are added to that detection signal. In view of this, only the unsprung vibration information can be obtained by making it pass through a BPF that allows an unsprung resonant frequency band to pass therethrough.

The vehicle wheel speed sensor 13 measures a rotational speed of the vehicle wheel. When the unsprung portion of the vehicle wheel vibrates, the rotational speed also fluctuates. In view of this, only the unsprung vibration information can be obtained if a BPF that allows an unsprung resonant frequency band to pass therethrough is inserted and only components caused due to unsprung vibrations are extracted in a manner similar to that described above.

The sprung acceleration sensor 14 measures acceleration of the sprung portion (vehicle body V). The influence due to unsprung vibrations is transmitted to the sprung portion through the suspension, and hence the unsprung vibration information appears also in the sprung acceleration sensor. In view of this, only the unsprung vibration information can be obtained if a BPF that allows an unsprung resonant frequency band to pass therethrough is inserted and only components caused due to unsprung vibrations are extracted in a manner similar to that described above

Note that it is needless to say that there are no problems even if values obtained after integral calculus or differential calculus is performed at least one or more times are used as detection values of the four sensors.

Further, it is only necessary to obtain the unsprung vibration information, and hence the unsprung vibration information can be extracted from those measured signals also by measuring a distortion of a spring S12, measuring an air pressure in the case of an air spring, or measuring a flow rate or an internal pressure of hydraulic oil in the damper S13, for example.

(Input Example of State Signal)

Next, a form for inputting the state signals generated by the signal generator 40 into the control unit 50 will be described.

FIG. 24 shows an input waveform (output waveform of signal generator 40) of a state signal that is an ON/OFF signal into the control unit 50 (unsprung control arithmetic units 51 to 54).

By making setting to turn ON when a predetermined vibration level or higher is detected or turn OFF during a time period other than that, it is possible to indicate the presence/absence of the predetermined vibration level or higher. Magnitude of the vibration level can be indicated by, for example, an ON continuation time.

Setting ON to 1 and OFF to 0 facilitates setting of matrix parameters necessary for generation of the unsprung control commands for the wheels in the control unit 50 as described above. Note that a sudden change in a control command may be prevented by limiting a change rate of this ON/OFF signal or providing a filter.

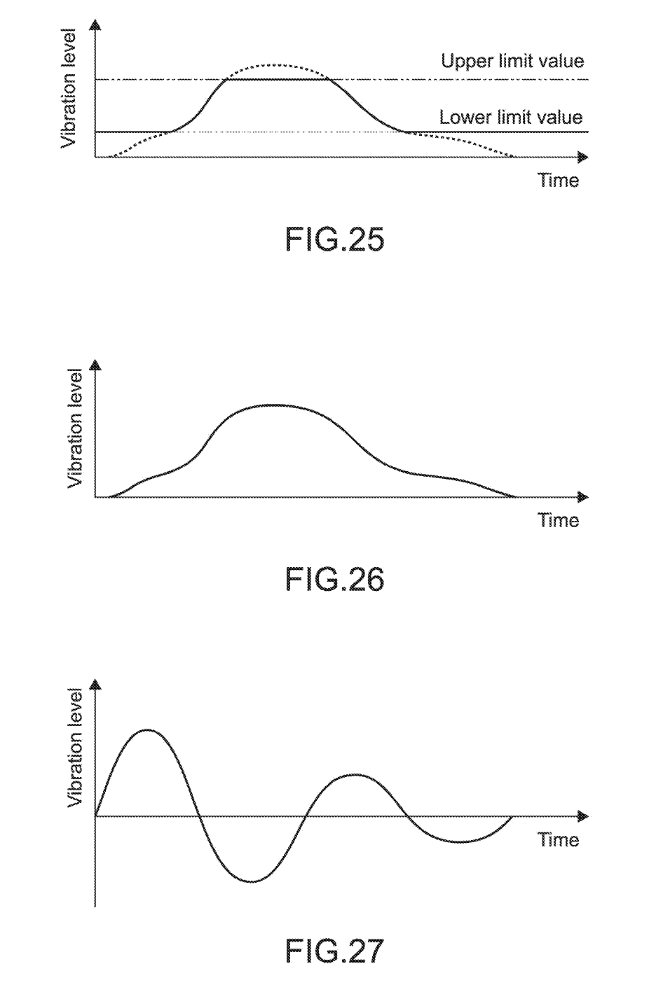

FIG. 25 shows an input waveform of a state signal into the control unit 50 (unsprung control arithmetic units 51 to 54) where upper and lower limit values are set with respect to a signal that fluctuates.

Setting the upper limit value to 1 and the lower limit value to 0 facilitates setting of matrix parameters necessary for generation of the unsprung control commands in the wheels in the control unit 50 in a manner similar to that described above.

It is not the ON/OFF signal, but a continuous signal that fluctuates in accordance with the unsprung vibration level, and hence it becomes possible to perform careful control in a manner that depends on the magnitude of vibrations. Further, even if the upper and lower limit values are set, the signal fluctuates in a manner that depends on the vibration level therebetween. Thus, it also serves to prevent the control command from being suddenly changed. Note that only either one of the upper and lower limit values may be set and they do not necessarily need to be normalized to 0 to 1.

FIG. 26 shows an input waveform obtained when the signal that fluctuates is used as the state signal as it is. Also in this case, the numerical value may be normalized on the basis of a certain reference.

Next, a generation method for the various signals of FIGS. 24 to 26 will be described.

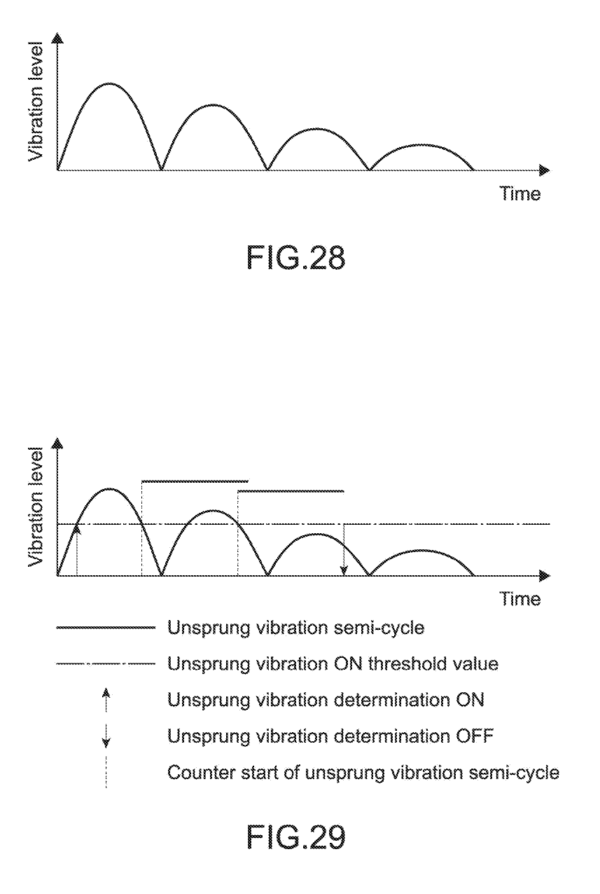

FIG. 27 shows an example of the waveform, in which unsprung vibration components have been extracted from a detection signal of any one of the sensors 11 to 14 (FIG. 23) that detect unsprung vibration states. FIG. 28 is an absolute value waveform of FIG. 27. FIG. 29 shows a method of generating the ON/OFF signal as shown in FIG. 24 from the waveform of FIG. 28.

Referring to FIG. 29, when the absolute value waveform exceeds the unsprung vibration ON threshold value, the unsprung vibration determination is turned ON. When the absolute value waveform falls below the unsprung vibration ON threshold value from the ON state, the determination is still ON and a counter using an unsprung vibration semi-cycle as a maximum starts to count up. If the absolute value exceeds the threshold value during counting up, the counter is reset. In contrast, if the absolute value does not exceed the threshold value before the counter value reaches the unsprung vibration semi-cycle, then the determination is turned OFF. In accordance with such an algorithm, the unsprung vibration state of each wheel can be determined on the basis of unsprung information acquired from the detector 10.

Note that the generation method for the ON/OFF determination result is not limited to the method above.

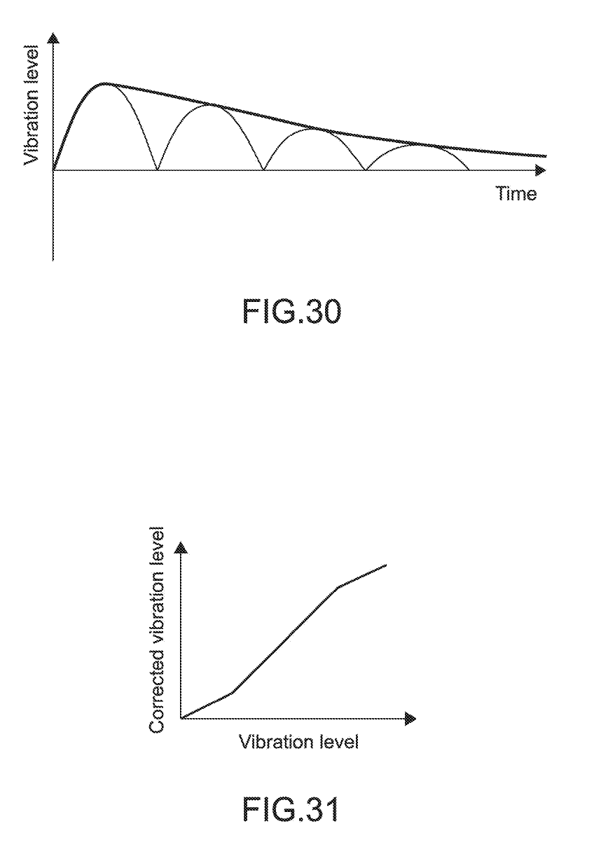

FIG. 30 is a conceptual diagram of a vibration level indicated by the envelope of the absolute value waveform shown in FIG. 28. If such vibration level information is used, it is possible to easily perform the determination as described above with reference to FIG. 25. If the setting of the upper and lower limit values of FIG. 25 is eliminated, it can be set as the input of FIG. 26.

Further, for example, as shown in FIG. 31, the vibration level of the state signal input into the control unit 50 can also be corrected in accordance with the magnitude of the vibration level of the sensor's detection value. In addition, the vibration level may be, for example, delayed through a filter or the like.

Note that a method in which the absolute value waveform is peak-held for a prescribed time, that value is gradually reduced after the prescribed time, and a larger value is employed if the absolute value waveform exceeds the peak-held absolute value waveform during processing of them is also applicable. Such a method also ultimately evaluates the magnitude of vibrations, and hence the same concept as the vibration level is used.

Here, semi-active control on the damper typically adjusts a valve opening degree of the damper. A final current command is a plus value including zero and a minus current value is not used. Therefore, in the case of the semi-active control, an unsprung current command input into the damper a peak amplitude in many cases.

Note that active control controls both plus and minus current values.

Further, the G matrix (G₁₁ to G₄₄) of the control unit 50 described above with reference to FIG. 6 is basically certain gains. Therefore, in view of the fact that the final control command is the peak amplitude, a W matrix (W_{FR}, W_{FL}, W_{RR}, and W_{RL}) also needs to be set to a peak amplitude.

Therefore, vibration level information of the peak amplitude indicated by the envelope of the absolute value of the vibration waveform as described above is made in an input form suitable for the state signal input into the control unit 50 (unsprung control command calculation units 51 to 54) for executing a semi-active control command.

Note that each state signal may be a peak-to-peak amplitude. In this case, for example, it is converted into the peak amplitude in each of the unsprung control command calculation units 51 to 54. Further, by outputting the state signal of the peak-to-peak amplitude, it becomes possible to calculate an unsprung control command for active control, for example.

The state signals favorably have an identical form in the unsprung vibration determination units 41 to 44. With this, it is possible to realize unsprung control using a control algorithm common to the wheels (in particular, left and right wheels) and to prevent control characteristics from being different between the wheels.

(Generation Method for State Signal)

Subsequently, a generation method for the state signals (corresponding to W_{FR}, W_{FL}, W_{RR}, and W_{RL}) in the signal generator 40, which considers the type, arrangement, and the like of the sensors that acquire the unsprung vibration information, will be described.

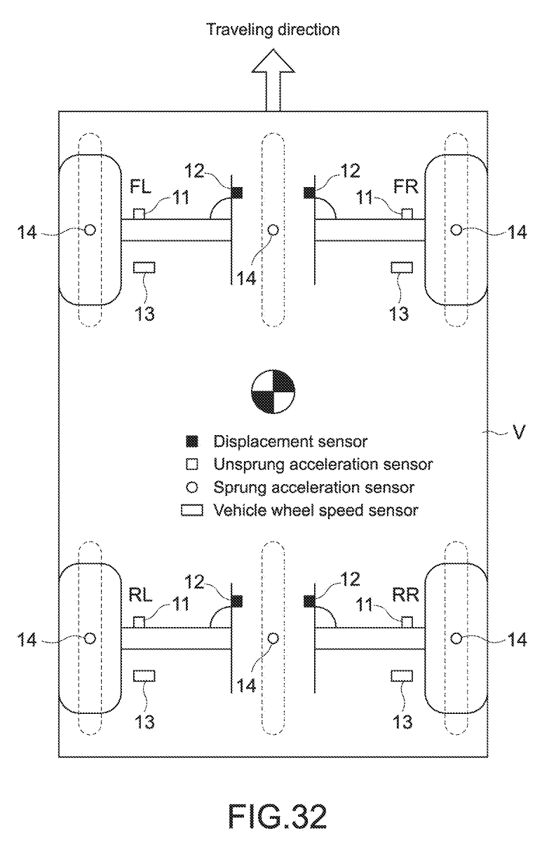

FIG. 32 shows an arrangement example of various sensors for acquiring unsprung vibration information of the wheels (FR, FL, RR, and RL). The sensors do not always need to be arranged at the illustrated positions and the type of sensors, the number of sensors, the positions of the sensors, and the like are set appropriately in a manner that depends on the vehicle type and the like.

The unsprung acceleration sensor 11, the displacement sensor 12, and the vehicle wheel speed sensor 13 are often arranged correspondingly to each of the wheels. Although both of the unsprung acceleration sensor 11 and the displacement sensor 12 are installed, only either one of them is often installed. An accessory of another vehicle control system such as a brake control system is typically used as the vehicle wheel speed sensor 13.

The sprung acceleration sensor 14 may be disposed in the sprung portion of each wheel or may be disposed between the FL wheel and the FR wheel or between the RL wheel and the RR wheel. The six sprung acceleration sensors 14 are shown in the figure. However, their positions are not limited to the illustrated example, and they are often disposed in any of regions indicated by the broken lines. In addition, any three sprung acceleration sensors 14 of the illustrated six sprung acceleration sensors 14, which are not in an identical straight line as viewed in a plane, is sometimes selected. Note that, as will be described later, a case where those three sprung acceleration sensors 14, which are not in the identical straight line as viewed in a plane, are randomly disposed will also be considered.

### Arrangement Example 1: Case where Unsprung Acceleration Sensors or Displacement Sensors are Placed on all Wheels

In this example, basically, unsprung vibration information items of the wheels are calculated using detection information items of the unsprung acceleration sensors 11 or the displacement sensors 12, state signals in the form as shown in FIGS. 24 to 26 are generated with respect to the wheels on the basis of those information items, and input into the unsprung control command calculation units 51 to 54 (FIG. 4).

Note that, in recent years, in most of vehicles, vehicle wheel speeds of all wheels are detected by the vehicle wheel speed sensors 13. Therefore, unsprung vibration information items may be calculated on the basis of those vehicle wheel speeds and state signals of the wheels may be generated on the basis of those information items.

In this embodiment, a configuration in which either of the unsprung vibration information detected by the unsprung acceleration sensor 11 or the displacement sensor 12 or the unsprung vibration information detected by the vehicle wheel speed sensor 13 is selected and the state signal of each wheel is generated is employed.

That is, in the case where the displacement sensors or the unsprung acceleration sensors are used, calculation accuracy of the unsprung vibration information is very high. However, it is necessary to prepare control rules for fail-safe as a countermeasure in case of sensor failure. In contrast, in the case where the information from the displacement sensor or the unsprung acceleration sensor as well as the vehicle wheel speed information are used, there is an advantage that the control can be continued by using vehicle wheel speed sensor information even if the displacement sensor or the unsprung acceleration sensor fails.

At this time, it is favorable to set the processing of the information acquired from the failed sensor not to be turned ON in the ON/OFF signal shown in FIG. 24 or to set the vibration level not to increase in the waveform signal that fluctuates, which is shown in FIGS. 25 and 26. In general, in case of sensor failure, the output becomes zero or fixed to the upper limit or the lower limit of the output range in many cases. Therefore, in calculating unsprung vibration information from this failed sensor, high-pass filter (HPF) or band-pass filter (BPF) processing by which low frequency components can be removed or some offset processing is favorably performed. With this, even if fail detection cannot be performed or the fail detection is delayed, the determination performed by this failed sensor is constantly OFF or zero and the determination based on outputs of normal sensors (e.g., vehicle wheel speed sensors) is automatically prioritized. Therefore, function continuation in case of sensor failure is ensured at a higher level.

Further, by selecting either the unsprung vibration information detected by the displacement sensors or the unsprung acceleration sensors or the unsprung vibration information detected by the vehicle wheel speed sensors, it is possible to determine an appropriate unsprung vibration state with respect to that wheel without needing control rules for fail safe. Further, there is an advantage that the generation algorithm for the state signals can be simplified in comparison with the case of calculating the state signals on the basis of the plurality of unsprung vibration information items and, if a failure occurs in a certain sensor, an appropriate unsprung vibration state can be determined without being influenced by the output of that sensor in which the failure has occurred.

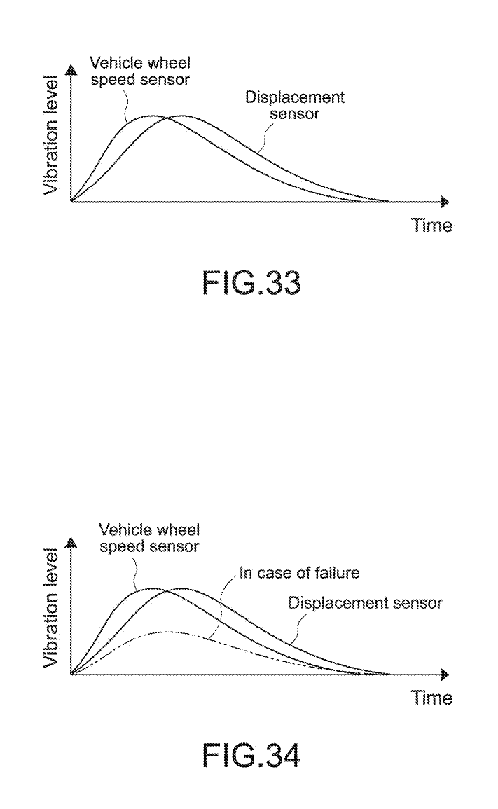

For example, as shown in FIG. 33, the unsprung vibration information detected by the displacement sensors and the unsprung vibration information detected by the vehicle wheel speed sensors have substantially similar waveforms. Therefore, even if one of the sensors fails, it is possible to acquire the unsprung vibration information without substantially changing the waveform.

In contrast, in the case where unsprung vibrations of that wheel are determined by calculating the average of the outputs of the plurality of sensors, an abnormality value of a sensor in which a failure has occurred is also reflected on the determination result. Therefore, for example, as shown in FIG. 34, the output becomes a half and performance deterioration occurs, and it becomes impossible to perform an appropriate unsprung vibration determination.

In addition, by selecting (high select) a detection signal including information on a largest unsprung vibration out of the plurality of unsprung vibration information items acquired from the plurality of sensors, it becomes possible to select information having higher reliability as the information on unsprung vibrations. Further, in performing cooperative control on unsprung vibrations of the plurality of wheels as described above, it can greatly contribute to generation of the unsprung control command, with which damping control can be performed on a wheel having relatively large unsprung vibrations and unsprung vibrations of each wheel can be efficiently suppressed.

Note that the unsprung vibration information calculated from the displacement sensors or the unsprung acceleration sensors and the unsprung vibration information calculated from the vehicle wheel speed sensor are different in system of unit, and hence they cannot be simply compared to each other in the high select processing. In view of this, it is, for example, favorable to perform correction by multiplying at least one unsprung vibration information item of those unsprung vibration information items by a gain such that those unsprung vibration information items have substantially equivalent levels or to adjust threshold values for the ON/OFF determination or the like in each of them when the same unsprung vibrations occur.

### Arrangement Example 2: Case where Displacement Sensors or Unsprung Acceleration Sensors are Placed Only on Front Left and Right Wheels

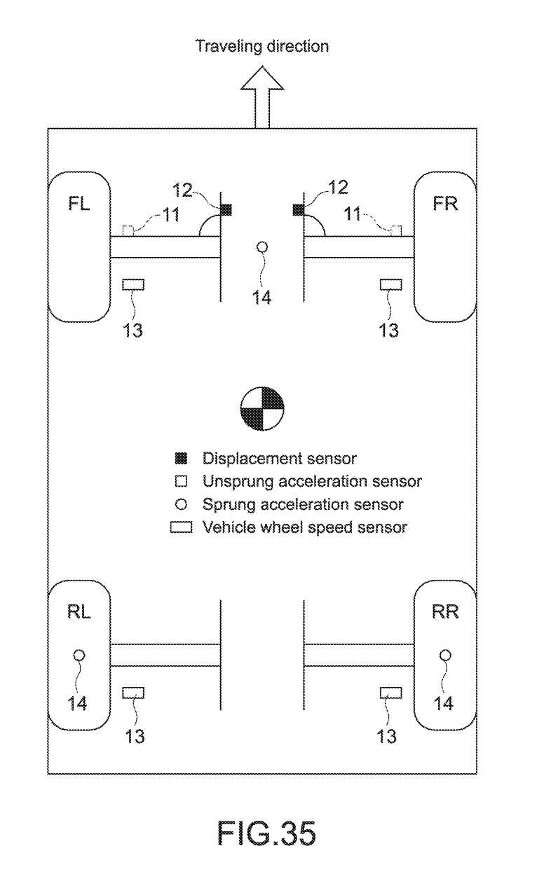

As shown in FIG. 35, a case where either the displacement sensors 12 or the unsprung acceleration sensors 11 are mounted on both of the left and right wheels in the front portion and those sensors are not mounted in the rear portion will be considered. In this example, as shown in FIG. 35, the sprung acceleration sensors 14 are mounted on a middle portion between the front left and right wheels and immediately on the rear wheels as viewed in a plane.

Processing of the front wheels (unsprung vibration determination of the FR wheel and the FL wheel and generation of state signals) is the same as Arrangement Example 1 above.

Processing of the rear wheels is basically extracting unsprung vibration information from signals of the sprung acceleration sensors 14 of the wheels, performing the unsprung vibration determination, and outputting them to the unsprung control arithmetic units 53 and 54 (FIG. 4).

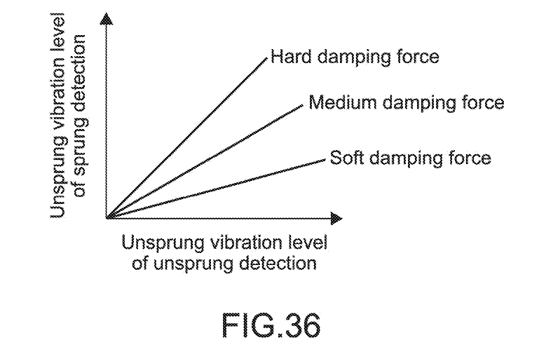

At this time, a detection level of the unsprung vibration information varies in a manner that depends on whether the unsprung vibration information is detected at the unsprung site (also including relative site of the suspension) or the unsprung vibration information is detected at the sprung site. Specifically, as shown in FIG. 36, for example, when the damping force of the damper is made soft, the unsprung portion very easily vibrate. Thus, the unsprung portion largely vibrates. However, it is difficult for vibrations to be transmitted to the sprung portion. Thus, when unsprung vibrations in the sprung portion is detected, a detection level thereof takes a small value. On the contrary, when the damping force of the damper is made hard, it is difficult for the unsprung portion to move. Thus, the unsprung portion does not largely vibrate. However, the transmission ratio to the sprung portion increases. Thus, when the unsprung vibration information in the sprung portion is detected, a detection level thereof takes a relatively large value.

Therefore, the damping force of the damper is substantially proportional to the control command to the damper, and hence, in the case of controlling the damping force of the damper with a current as in this embodiment, it is favorable to refer to information, with which the magnitude of the damping force characteristic can be determined, such as a current command and an actual current value. By correcting the unsprung vibration level on the basis of magnitude information of the damping force of the damper characteristic when calculating the unsprung vibration information from the sprung acceleration sensor 14, it becomes possible to enhance the calculation accuracy of the unsprung vibration information of the rear portion.

By the way, it cannot be said that the sprung acceleration sensor 14 has sufficiently high calculation accuracy of the unsprung vibration information as compared to the displacement sensor 12 or the unsprung acceleration sensor 11. Therefore, in the case of that sensor arrangement, it is favorable to preview the unsprung vibration information of the front wheels, for the rear wheels. Further, the information of the vehicle wheel speed sensor 13 of each rear wheel may also be used and the state signal of each rear wheel may be generated on the basis of a high select result of the unsprung vibration determination using that vehicle wheel speed information, the unsprung vibration information detected by the sprung acceleration sensor 14 of each rear wheel, and the unsprung vibration information of the front wheels. With this, the advantages related to enhancement in accuracy of the unsprung vibration determination, the countermeasure in case of sensor failure, and the like are enhanced.

### Arrangement Example 3: Case where Only Three Sprung Acceleration Sensors are Placed

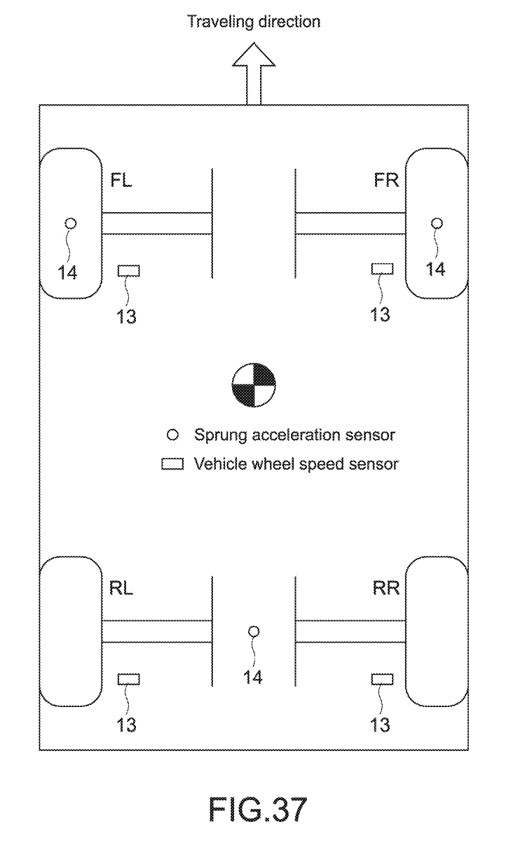

In the case where the displacement sensors or the unsprung acceleration sensors are not mounted (vehicle wheel speed sensors are optionally installed), it is favorable that, as shown in FIG. 37, a total of three sprung acceleration sensors 14 be mounted directly on the front wheels and on a middle portion between the rear left and right wheels.

Regarding the front wheels, for example, as described above in Arrangement Example 2, it is only necessary to perform the unsprung vibration determination of the front wheels and generation of the state signals using the outputs of the sprung acceleration sensors 14 and the outputs of the vehicle wheel speed sensors.

On the other hand, regarding the rear wheels, the detection value of the sprung acceleration sensor 14 mounted on the center of the rear left and right wheels is mainly used. This acceleration sensor 14 includes information on unsprung vibrations of both of the rear left and right wheels. However, when those unsprung vibrations are in left and right phases just opposite to each other, the acceleration detection value mounted on the sprung center of them becomes theoretically zero.

In view of this, the unsprung vibration information obtained from the sprung acceleration sensor 14 at the rear center is basically handled as the unsprung vibration information common to the rear left and right wheels and the unsprung information is also used from the vehicle wheel speed information items of the wheels at the same time. In this manner, the reliability is further enhanced. Further, the reliability can be further enhanced by previewing the unsprung vibration information (both of sprung acceleration and vehicle wheel speed) of the front portion for the rear portion.

The unsprung vibration information of each wheel acquired in accordance with the arrangement example of the sensors in this example is applicable to the suspension control apparatus including the control unit 50 shown in FIG. 22, for example.

### Arrangement Example 4: Case where Three Sprung Acceleration Sensor are Randomly Placed

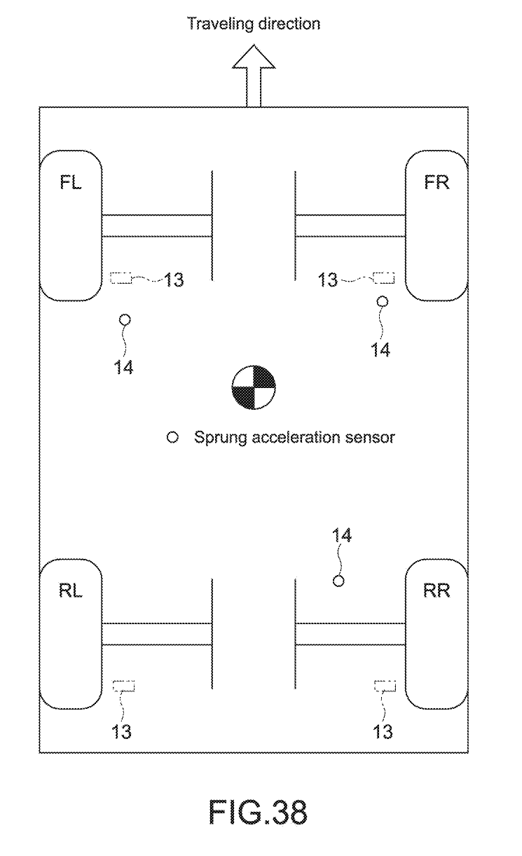

The plurality of sprung acceleration sensors are not limited to be mounted correspondingly to the wheels, and can be, as shown in FIG. 38, mounted at random positions on the vehicle body (vehicle wheel speed sensors are optionally installed). An acquisition method for the unsprung vibration information of each wheel at this time will be described.

In the case where the vehicle wheel speed sensors 13 are mounted, it is possible to simply acquire unsprung vibration information of each wheel on the basis of the outputs of those vehicle wheel speed sensors 13.

On the other hand, each sprung acceleration sensor 14 indirectly acquires unsprung vibration information of each wheel through the sprung portion of that wheel. Therefore, although it is not impossible to acquire unsprung vibration information of each wheel on the basis of the outputs of the sprung acceleration sensors 14 and the outputs of the vehicle wheel speed sensors 13, it is difficult to identify which of the wheels that unsprung information is related to. Therefore, as described below, it is favorable to acquire it as the unsprung vibration information common to the wheels.

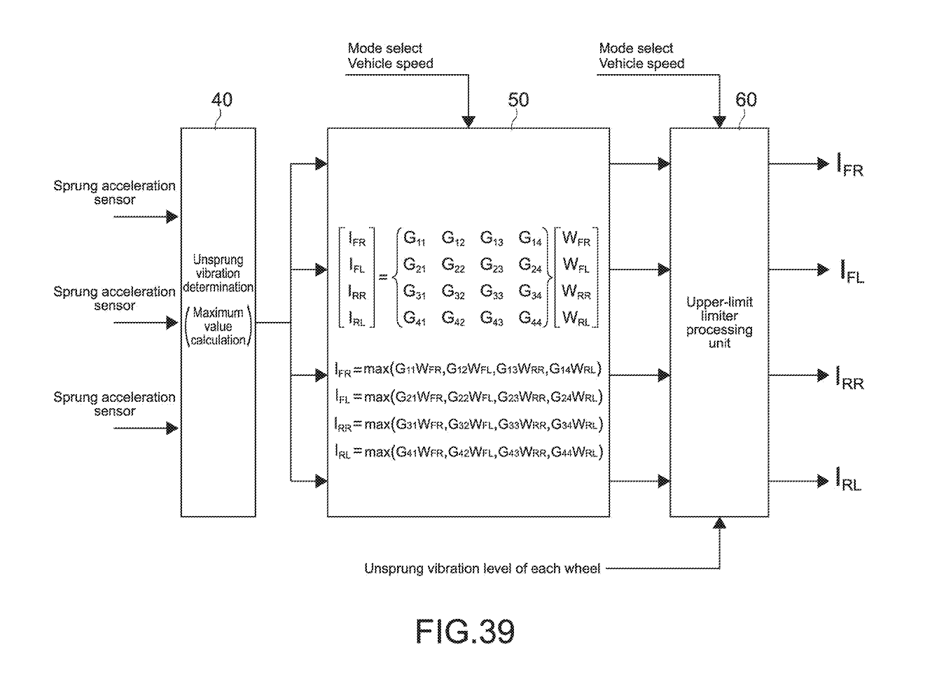

In the case where the vehicle wheel speed sensors 13 are not mounted, it is necessary to acquire unsprung vibration information of the wheels only from the sprung acceleration sensors 14. In this case, in each of the three sprung acceleration sensors 14, unsprung vibration frequency components can be extracted, the unsprung vibration determination can be performed, a maximum value of the thus obtained determination results can be selected, and a state signal common to all the four wheels can be generated using the result. In this case, by the common state signal being input into the control unit 50 (unsprung control command calculation units 51 to 54) as shown in FIG. 39, the unsprung control command output to the damper 30 of each wheel is generated.

In this example, the unsprung control commands to the wheels is generated on the basis of all the identical state signals. Therefore, unsprung vibrations of each wheel can be cooperatively controlled by setting the values of the gain matrix G₁₁ to G₄₄ of the control unit 50 in a manner that depends on control purposes, for example, for the purpose of obtaining the same feeling as the conventional damper. Further, in accordance with this example, the number of sensors necessary for acquiring the unsprung vibration information of each wheel can be largely reduced, and hence it becomes possible to realize semi-active control on each damper at low costs.

(Smooth High-Select Processing)

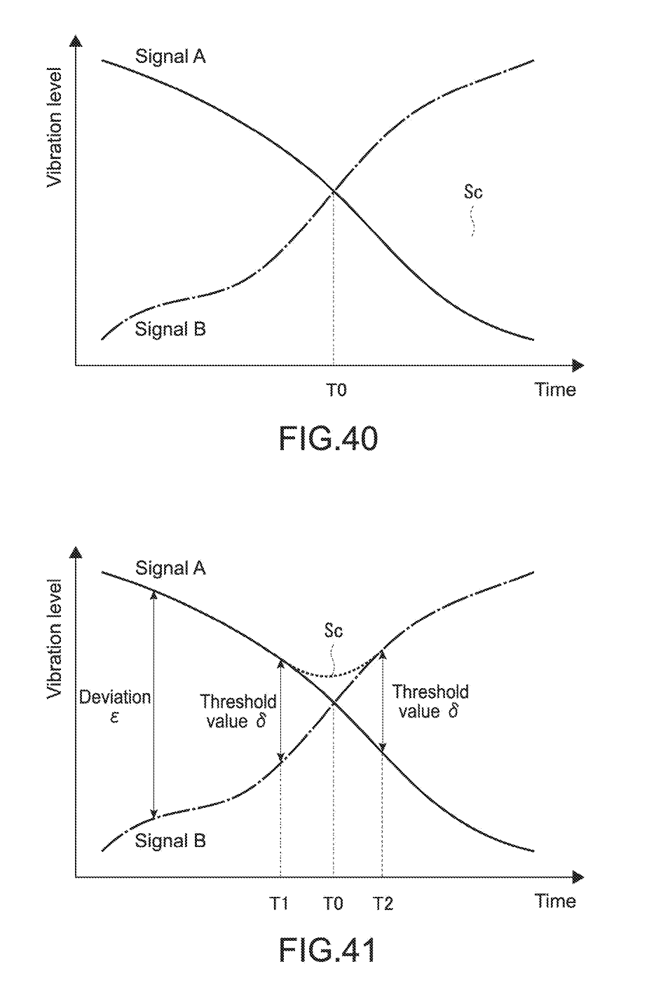

As described above, when generating the state signal of each wheel, the signal generator 40 (unsprung vibration determination units 41 to 44) of this embodiment is configured to select the maximum value of the unsprung vibration information detected by, typically, the plurality of sensors such as the vehicle wheel speed sensors, the unsprung acceleration sensors, and the sprung acceleration sensors (see FIG. 33). Now, an example in which such high select processing is performed on the basis of two sensor signals whose signal levels change over time in a manner different from each other is described with reference to FIG. 40. In a time before a point of time T0 at which two signals A and B intersect each other, the vibration level of the signal A is selected and the vibration level of the signal B is selected in a time after the point of time T0.

Here, if a change ratio of the vibration levels of the signals A and B is excessively different before and after the point of time T0 as shown in FIG. 40, there is a fear that it may cause a sudden change in the state signal (and an unsprung control command generated on the basis of this) and smooth damping force control on the damper may be difficult, which may deteriorate the vehicle feeling.

In order to overcome such a problem, it is favorable to perform smooth high-select processing as conceptually shown in FIG. 41, for example.

The signal generator 40 (unsprung vibration determination units 41 to 44) of this embodiment includes a smooth high-select processing unit (smoothing processing unit) that smoothes the intersection of the signals A and B.

FIG. 41 is a conceptual diagram for describing the smooth high-select processing. In this processing, as shown in FIG. 41, a virtual signal line Sc for smoothing a change between the vibration levels of the signals A and B is set between predetermined points of time T1 and T2 before and after the point of time T0, and a vibration level on the virtual signal line Sc is selected as the vibration level selected (high select) between the points of time T1 to T2. With this, it becomes possible to prevent the vibration level from suddenly changing due to the high select processing and realize smooth damping force control on the damper.

An example of the setting method for the virtual signal line Sc will be described.

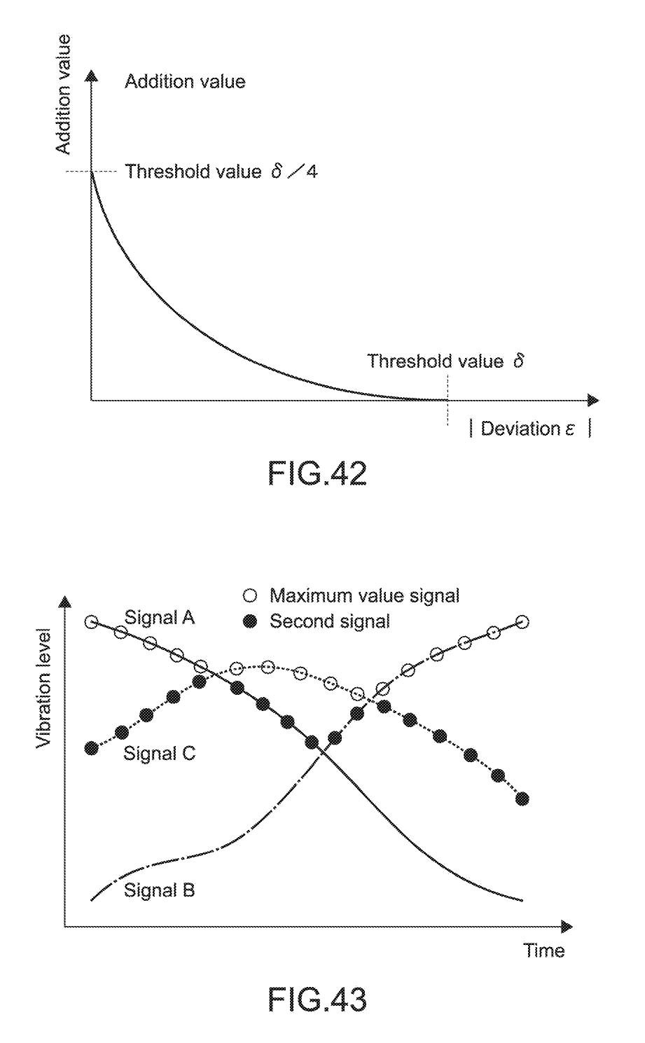

Assuming that a deviation between the signal A and the signal B is indicated by E and a smoothing threshold value with respect to the deviation e is indicated by δ, the virtual signal line Sc is set by adding an addition value α shown in FIG. 42 to a maximum value selected from the signals A and B in a region in which the absolute value of the deviation c is equal to or smaller than the threshold value δ. The addition value α shown in FIG. 42 can be expressed by Expression (9) below.

α=(|ε|−δ)²/(4δ) (5)

It should be noted that the addition value α is not limited to the value expressed by Expression (5) above and an appropriate value may be employed.

The detection signals that are targets of the smooth high select processing are not limited to the two signals and may be three or more signals. In this case, as shown in FIG. 43, it is only necessary to extract a maximum value signal and a second signal (second largest signal) from a plurality of signals and perform addition processing of the addition value α of FIG. 42 (Expression (5)) considering them as the signals A and B of FIG. 41. It is because the addition value α is set as the absolute value of the deviation s, and hence the same result is obtained even if it is applied to the maximum value signal and the second signal.

As described above, by performing the smooth high-select processing on the basis of the plurality of detection signals, it is possible to suppress sudden changes in the state signal and the unsprung control command generated on the basis of this. With this, sudden changes in the damping force are suppressed, and it becomes possible to prevent the vehicle feeling or the driving comfort from being deteriorated. Thus, for realizing such processing, it is only necessary to incorporate the “smooth high-select processing unit” that performs such processing in each of the unsprung vibration determination units 41 to 44.

Note that this smooth high-select processing may be incorporated in the control unit 50 (unsprung control command calculation units 51 to 54) instead of the signal generator 40. In this case, sudden changes in the unsprung control commands generated by performing high select processing on the state signals of the wheels can be suppressed. Therefore, actions and effects similar to those described above can be obtained.

Note that, for suppressing sudden changes in the maximum value signals, it is also conceivable to perform smoothing by passing the maximum value signals of the signals A and B through a low-pass filter (LPF). However, in this case, there is a disadvantage that a phase delay occurs, and there is a fear that the control may be delayed, which deteriorate the vehicle feeling due to insufficient damping.

In contrast, in accordance with the smooth high-select processing, it is possible to overcome the phase delay problem and realize appropriate damping control without delaying the control.

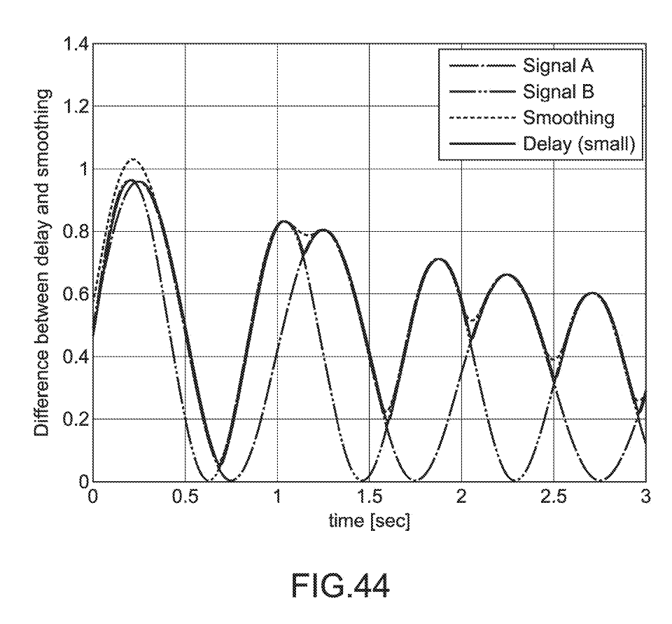

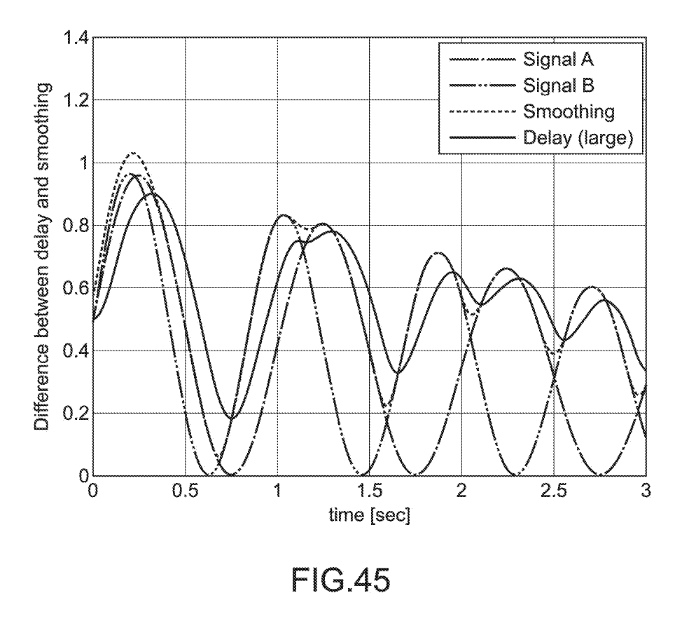

For example, FIGS. 44 and 45 show results of comparison of the case where smoothing associated with the high select processing of the signal A and the signal B is carried out in smooth high-select processing (broken line) with the case where it is carried out in LPF processing (solid line). FIG. 44 shows a case where the delay of the filter is shortened such that the phase delay hardly occurs in the smoothing using the LPF. FIG. 45 shows a case where the delay of the filter is increased such that an smoothing effect using the LPF is at the same level as that of the smooth high-select processing.

As can be seen from FIG. 44, when the phase delay is shortened in the smoothing using the LPF, the smoothing effect is hardly obtained. Further, as can be seen from FIG. 45, when the smoothing effect is increased, the phase delay is increased.

With this, it can be seen that the smooth high-select processing has an advantage that sudden changes can be suppressed (smoothed) in the high select processing while avoiding the phase delay.

Hereinabove, the embodiments of the present invention have been described. As a matter of course, the present invention is not limited to the above-mentioned embodiments and various changes can be added.

For example, although the description has been made exemplifying the front or rear left and right two wheels or all the wheels as the target wheels of the unsprung cooperative control in the above embodiments, it is not limited thereto. For example, the unsprung cooperative control may be performed by setting a pair of two wheels in diagonal relationship or front and rear two wheels on one of left- and right-hand sides as the targets.

Further, the configuration in which, in the signal generator 40, the unsprung vibration state of each wheel is determined on the basis of the signal selected (high select) from the plurality of sensor signals, the state signal generated on the basis of this determination is input into the control unit 50, and thus the unsprung control command of each wheel is generated is employed in the above embodiments. However, it is not limited thereto. That is, the state signal of each wheel input into the control unit 50 may be generated using only a signal of a dedicated sensor mounted on each wheel. Also in such a case, it is possible to generate the unsprung control commands for mutually and cooperatively controlling the plurality of wheels in the control unit 50.

Similarly, the state signal generated on the basis of the result of the determination made on the basis of the signal selected (high select) from the plurality of sensor signals is not limited to be input into the control unit 50 that generates the unsprung control commands for mutually and cooperatively controlling the plurality of wheels. That is, the signal generator 40 of this embodiment is also applicable in a suspension control apparatus including a control unit not aiming at cooperative control on the plurality of wheels.

### REFERENCE SIGNS LIST

10 detector
11 unsprung acceleration sensor
12 displacement sensor
13 vehicle wheel speed sensor
14 sprung acceleration sensor
20 suspension control apparatus
30 damper
40 signal generator
41 to 44 unsprung vibration determination unit
50 control unit
51 to 54 unsprung control command calculation unit
60 upper-limit limiter processing unit
100 suspension control system

1. A suspension control apparatus, comprising:
a signal generator that generates a first state signal regarding unsprung vibrations of a first wheel and a second state signal regarding unsprung vibrations of a second wheel; and
a control unit that generates, on the basis of the first and second state signals, a control signal for mutually and cooperatively controlling a first damper mounted on the first wheel and a second damper mounted on the second wheel.

2. The suspension control apparatus according to claim 1, wherein
the second wheel is a wheel opposite to the first wheel in left- and right-hand directions, and
the control unit that generates, when detecting unsprung vibrations of at least one of the first and second wheels, a first control command to electrically control a vibration damping characteristic of the first damper and a second control command to electrically control a vibration damping characteristic of the second damper, as the control signal.

3. The suspension control apparatus according to claim 2, wherein
the control unit generates the first and second control commands such that the vibration damping characteristic of the first damper is larger than the vibration damping characteristic of the second damper when the first state signal is larger than the second state signal.

4. The suspension control apparatus according to claim 2, wherein
the control unit generates the first and second control commands such that the vibration damping characteristic of the first damper is smaller than the vibration damping characteristic of the second damper when the first state signal is larger than the second state signal.

5. The suspension control apparatus according to claim 2, wherein
the control unit generates the first and second control commands such that the vibration damping characteristic of the first damper is equal to the vibration damping characteristic of the second damper when the first state signal is larger than the second state signal.

6. The suspension control apparatus according to claim 2, wherein
the control unit includes
a first control command calculation unit that generates the first control command on the basis of a maximum value selected from a multiplication value obtained by multiplying the first state signal by a first gain and a multiplication value obtained by multiplying the second state signal by a second gain different from the first gain, and
a second control command calculation unit that generates the second control command on the basis of a maximum value selected from a multiplication value obtained by multiplying the first state signal by a third gain identical to the second gain and a multiplication value obtained by multiplying the second state signal by a fourth gain identical to the first gain.

7. The suspension control apparatus according to claim 6, wherein
the signal generator further generates a third state signal regarding unsprung vibrations of a third wheel opposite to the first wheel in front and rear directions and a fourth state signal regarding unsprung vibrations of a fourth wheel opposite to the third wheel in the left- and right-hand directions,
the first control command calculation unit generates the first control command on the basis of a maximum value selected from the multiplication value obtained by multiplying the first state signal by the first gain, the multiplication value obtained by multiplying the second state signal by the second gain, a multiplication value obtained by multiplying the third state signal by a fifth gain, and a multiplication value obtained by multiplying the fourth state signal by a sixth gain different from the fifth gain, and
the second control command calculation unit generates the second control command on the basis of a maximum value selected from the multiplication value obtained by multiplying the first state signal by the third gain, the multiplication value obtained by multiplying the second state signal by the fourth gain, a multiplication value obtained by multiplying the third state signal by a seventh gain identical to the sixth gain, and a multiplication value obtained by multiplying the fourth state signal by an eighth gain identical to the fifth gain.

8. The suspension control apparatus according to claim 6, wherein
the first and second wheels are left and right front wheels.

9. The suspension control apparatus according to claim 6, wherein
the first and second wheels are left and right rear wheels.

10. The suspension control apparatus according to claim 6, wherein
the control unit variably controls values of the first to fourth gains in a manner that depends on a speed of a vehicle.

11. The suspension control apparatus according to claim 10, wherein
the control unit
sets the second gain to a value smaller than the fourth gain and reduces a difference between the second gain and the fourth gain as the speed of the vehicle increases when the speed of the vehicle is within a first speed range, and
sets the second gain to a value equal to or larger than the fourth gain and increases the difference between the second gain and the fourth gain as the speed of the vehicle increases when the speed of the vehicle is within a second speed range equal to or higher than the first speed range.

12. The suspension control apparatus according to claim 1, further comprising
a limiter processing unit capable of individually setting, in a manner that depends on magnitude of unsprung vibrations of each of a plurality of wheels, an upper-limit limiter value in a direction in which a damping force characteristic increases, with respect to a control command for each wheel.

13. The suspension control apparatus according to claim 12, wherein
the limiter processing unit monitors magnitude of unsprung vibrations of each wheel, and gradually reduces a control command to the wheel whose unsprung vibrations become larger, in a direction in which the damping force characteristic decreases, as the unsprung vibrations become larger.

14. The suspension control apparatus according to claim 12, wherein
the limiter processing unit changes the upper-limit limiter value on the basis of a speed of a vehicle.

15. The suspension control apparatus according to claim 1, wherein
the signal generator acquires, from a plurality of sensors mounted on a vehicle, a plurality of detection signals including information regarding unsprung vibrations of the first wheel, and generates the first state signal on the basis of the plurality of detection signals.

16. A suspension control method, comprising:
acquiring a plurality of unsprung vibration information items regarding unsprung vibrations of each of a plurality of wheels; and
generating a control signal for mutually and cooperatively controlling a plurality of dampers mounted on the plurality of wheels on the basis of the plurality of unsprung vibration information items.

17. The suspension control method according to claim 16, wherein
the step of generating the control signal includes
generating, on the basis of a maximum value selected from a multiplication value obtained by multiplying a first state signal regarding unsprung vibrations of a first wheel by a first gain and a multiplication value obtained by multiplying a second state signal regarding unsprung vibrations of a second wheel, which is opposite to the first wheel in left- and right-hand directions, by a second gain different from the first gain, a first control command to electrically control a vibration damping characteristic of a first damper mounted on the first wheel, and
generating, on the basis of a maximum value selected from a multiplication value obtained by multiplying the first state signal by a third gain identical to the second gain and a multiplication value obtained by multiplying the second state signal by a fourth gain identical to the first gain, a second control command to electrically control a vibration damping characteristic of a second damper mounted on the second wheel.

18. A non-transitory computer readable recording medium recording a program that causes a suspension control apparatus to execute the steps of:
acquiring a first state signal regarding unsprung vibrations of a first wheel, and a second state signal regarding unsprung vibrations of a second wheel opposite to the first wheel in left- and right-hand directions;
calculating a multiplication value obtained by multiplying the first state signal by a first gain, calculating a multiplication value obtained by multiplying the second state signal by a second gain different from the first gain, and generating, on the basis of a maximum value selected from the multiplication values, a first control command to electrically control a vibration damping characteristic of a first damper mounted on the first wheel; and
calculating a multiplication value obtained by multiplying the first state signal by a third gain identical to the second gain, calculating a multiplication value obtained by multiplying the second state signal by a fourth gain identical to the first gain, and generating, on the basis of a maximum value selected from the multiplication values, a second control command to electrically control a vibration damping characteristic of a second damper mounted on the second wheel.
